(19) United States
(12) Patent Application Publication
(10) Pub. No.: US 2026/0323774 A1
(43) Pub. Date: Oct. 15, 2026

(54) MANAGING INACTIVE STATE MULTICAST DATA RECEPTION

(71) Applicant: GOOGLE LLC, Mountain View, CA (US)

(72) Inventors: Chih-Hsiang Wu, Taoyuan City (TW); Ching-Jung Hsieh, Taoyuan City (TW)

(21) Appl. No.: 19/483,969

(22) PCT Filed: May 13, 2024
(86) PCT No.: PCT/US2024/029176

§ 371 Date: Nov. 12, 2025

Related U.S. Application Data
(60) Provisional application No. 63/502,065, filed on May 12, 2023.

(51) Int. Cl. H04W 76/40; H04W 76/27

(52) U.S. Cl. CPC H04W 76/40; H04W 76/27

(57) ABSTRACT

A method for receiving multicast and/or broadcast services (MBS) data can be implemented in a user equipment (UE). The method can include receiving (1436), from a radio access network (RAN), first MBS data in a connected state of a protocol for controlling radio resources. The method can include receiving (1454), from the RAN, multicast configuration for an inactive state of the protocol. The method can still further include receiving (1463) second MBS data in the inactive state, in accordance with the multicast configuration for the inactive state. Other apparatuses and methods are described.

### CROSS-REFERENCE TO RELATED APPLICATION

This application claims priority to and the benefit of the filing date of provisional U.S. Patent Application No. 63/502,065 entitled “Managing Inactive State Multicast Data Reception,” filed on May 12, 2023. The entire content of the provisional application is hereby expressly incorporated herein by reference.

### FIELD OF THE DISCLOSURE

This disclosure relates to wireless communications and, more particularly, to enabling one or more multicast and/or broadcast services (MBS) for a user equipment (UE) operating in an inactive state.

### BACKGROUND

The background description provided herein is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

In telecommunication systems, the Packet Data Convergence Protocol (PDCP) sublayer of the radio protocol stack provides services such as transfer of user-plane data, ciphering, integrity protection, etc. For example, the PDCP sublayer defined for the Evolved Universal Terrestrial Radio Access (EUTRA) radio interface (see Third Generation Partnership Project (3GPP) specification TS 36.323) and New Radio (NR) (see 3GPP specification TS 38.323) provides sequencing of protocol data units (PDUs) in the uplink direction from a user device (also known as a user equipment or “UE”) to a base station, as well as in the downlink direction from the base station to the UE. The PDCP sublayer also provides services for signaling radio bearers (SRBs) to the Radio Resource Control (RRC) sublayer. The PDCP sublayer further provides services for data radio bearers (DRBs) to a Service Data Adaptation Protocol (SDAP) sublayer or a protocol layer such as an Internet Protocol (IP) layer, an Ethernet protocol layer, and an Internet Control Message Protocol (ICMP) layer. Generally speaking, the UE and a base station can use SRBs to exchange RRC messages as well as non-access stratum (NAS) messages, and can use DRBs to transport data on a user plane.

The UE in some scenarios can concurrently utilize resources of multiple nodes (e.g., base stations or components of a distributed base station or disaggregated base station) of a radio access network (RAN), interconnected by a backhaul. When these network nodes support different radio access technologies (RATs), this type of connectivity is referred to as multi-radio dual connectivity (MR-DC). When operating in MR-DC, the cell(s) associated with the base station operating as a master node (MN) define a master cell group (MCG), and the cells associated with the base station operating as a secondary node (SN) define the secondary cell group (SCG). The MCG covers a primary cell (PCell) and zero, one, or more secondary cells (SCells), and the SCG covers a primary secondary cell (PSCell) and zero, one, or more SCells. The UE communicates with the MN (via the MCG) and the SN (via the SCG). In other scenarios, the UE utilizes resources of one base station at a time, in single connectivity (SC). The UE in SC only communicates with the MN, via the MCG. A base station and/or the UE determines when the UE should establish a radio connection with another base station. For example, a base station can determine to hand the UE over to another base station, and initiate a handover procedure. The UE in other scenarios can concurrently utilize resources of another RAN node (e.g., a base station or a component of a distributed or disaggregated base station), interconnected by a backhaul.

UEs can use several types of SRBs and DRBs. So-called “SRB1” resources carry RRC messages, which in some cases include NAS messages over the dedicated control channel (DCCH), and “SRB2” resources support RRC messages that include logged measurement information or NAS messages, also over the DCCH but with lower priority than SRB1 resources. More generally, SRB1 and SRB2 resources allow the UE and the MN to exchange RRC messages related to the MIN and embed RRC messages related to the SN, and can also be referred to as MCG SRBs. “SRB3” resources allow the UE and the SN to exchange RRC messages related to the SN, and can also be referred to as SCG SRBs. Split SRBs allow the UE to exchange RRC messages directly with the MN via lower-layer resources of the MN and the SN. Further, DRBs terminated at the MN and using the lower-layer resources of only the MN can be referred as MCG DRBs, DRBs terminated at the SN and using the lower-layer resources of only the SN can be referred as SCG DRBs, and DRBs terminated at the MN or SN but using the lower-layer resources of both the MN and the SN can be referred to as split DRBs. DRBs terminated at the MN but using the lower-layer resources of only the SN can be referred to as MN-terminated SCG DRBs. DRBs terminated at the SN but using the lower-layer resources of only the MN can be referred to as SN-terminated MCG DRBs.

UEs can perform handover procedures to switch from one cell to another, whether in SC or DC operation. These procedures involve messaging (e.g., RRC signaling and preparation) among RAN nodes and the UE. The UE may handover from a cell of a serving base station to a target cell of a target base station, or from a cell of a first distributed unit (DU) of a serving base station to a target cell of a second DU of the same base station, depending on the scenario. In DC scenarios, UEs can perform PSCell change procedures to change PSCells. These procedures involve messaging (e.g., RRC signaling and preparation) among RAN nodes and the UE. The UE may perform a PSCell change from a PSCell of a serving SN to a target PSCell of a target SN, or from a PSCell of a source DU of a base station to a PSCell of a target DU of the same base station, depending on the scenario. Further, the UE may perform handover or PSCell change within a cell for synchronous reconfiguration.

Today, a 5G NR system enables resource-efficient delivery of multicast/broadcast services (MBS). For a broadcast communication service, the network provides the same service and the same specific content data simultaneously to all UEs in a geographic area (i.e., all UEs in the broadcast service area are authorized to receive the data). The network can deliver a broadcast communication service to the UEs using a broadcast session. A UE can receive a broadcast communication service in RRC_IDLE, RRC_INACTIVE and RRC_CONNECTED state. For multicast communication service, the network provides the same service and the same specific content data simultaneously to a dedicated set of UEs (i.e., not all UEs in the multicast service area are authorized to receive the data), and the network can deliver a multicast communication service to the UEs using a multicast session. 5G NR provides both point-to-point (PTP) and point-to-multipoint (PTM) delivery methods for the transmission of MBS packet flows over the radio interface. In PTP communications, a RAN node transmits different copies of each MBS data packet to different UEs over the radio interface. On the other hand, in PTM communications, a RAN node transmits a single copy of each MBS data packet to multiple UEs over the radio interface.

The RAN supports multicast only for UEs operating in the RRC_CONNECTED state. However, this may not fully satisfy the requirements of Mission Critical Services, especially for cells with a large number of UEs according. Also, to it is not power-efficient to always keep UEs in the RRC_CONNECTED state.

### SUMMARY

The techniques discussed below provide multicast for UEs in the RRC_INACTIVE state. More particularly, the techniques allow a RAN and a UE to manage the relevant multicast radio bearer(s) (MRB(s)) configured for the connected state and the inactive state, which the RAN generally configures using a dedicated and a shared method, respectively.

An example embodiment of these techniques is a method implemented in a user equipment (UE) for receiving multicast and/or broadcast services (MBS) data. The method can comprise: receiving, from a radio access network (RAN), first MBS data in a connected state of a protocol for controlling radio resources; receiving, from the RAN, multicast configuration for an inactive state of the protocol; and receiving, from the RAN, second MBS data in the inactive state, in accordance with the multicast configuration for the inactive state.

Another example embodiment of these techniques is a method implemented in a radio access network (RAN) node, comprising: transmitting, to a UE, a first multicast configuration for a connected state of a protocol for controlling radio resources; transmitting to the UE, first MBS data according to the first multicast configuration; and transmitting, to the UE, a second multicast configuration for receiving second MBS data in an inactive state of the protocol.

Still another embodiment of these techniques is an apparatus comprising processing hardware and configured to implement of the methods above.

### BRIEF DESCRIPTION OF THE DRAWINGS

FIG. 1A is a block diagram of an example system in which the techniques of this disclosure for managing multicast radio resources may be implemented;

FIG. 1B is a block diagram of an example base station in which a centralized unit (CU) and a distributed unit (DU) can operate in the system of FIG. 1A;

FIG. 2A is a block diagram of an example protocol stack according to which the UE of FIG. 1A can communicate with base stations of FIG. 1A;

FIG. 2B is a block diagram of an example protocol stack according to which the UE of FIG. 1A can communicate with a DU and a CU of a base station;

FIG. 3 is a block diagram of an example tunnel architectures for MBS sessions and PDU sessions;

FIG. 4 is a block diagram of an example tunnel architectures for MRBs and DRBs;

FIGS. 5A-5B are messaging diagram of example scenarios in which a CN and a base station of FIGS. 1A and/or 1B manage the transmission of downlink data for a MBS session to a UE operating in a connected state or inactive state;

FIGS. 6A-6B are messaging diagrams of example scenarios in which a base station of FIGS. 1A and/or 1B manages the transmission of downlink data for a UE during RRC connection resumption;

FIGS. 7A-7C are messaging diagrams of example scenarios in which a base station of FIGS. 1A and/or 1B manages the transmission of downlink data for a UE operating in an inactive state and accessing a new base station;

FIG. 8 is a flow diagram illustrating that a source RAN node configures a UE to perform MBS data reception in a connected state and in an inactive state and transmit the configuration parameters to a target RAN node;

FIGS. 9A-9C are flow diagrams illustrating that a target RAN node receives configuration parameters for a connected state and a multicast configuration for an inactive state for a UE and reconfigures the UE the multicast configuration for the inactive state;

FIG. 10 is a flow diagram illustrating that a RAN node performs an RRC resume procedure with a UE and may configure the UE to receive MBS in connected state;

FIGS. 11A-11B are flow diagrams illustrating that a RAN node configures a UE to receive multicast data in the inactive state and notifies the UE of the MBS service status;

FIG. 12 is a flow diagram illustrating that a UE transitions to the inactive state to receive MBS data in the inactive state and suspends the connected state MRB(s);

FIGS. 13A-13E are flow diagrams illustrating that a UE manages the inactive state MRB(s) in response to state transitions;

FIG. 14 is a flow diagram of a method, implemented in a UE, for receiving multicast and/or broadcast services (MBS) data; and

FIG. 15 is a flow diagram of a configuration method implemented in a RAN node.

### DETAILED DESCRIPTION OF THE DRAWINGS

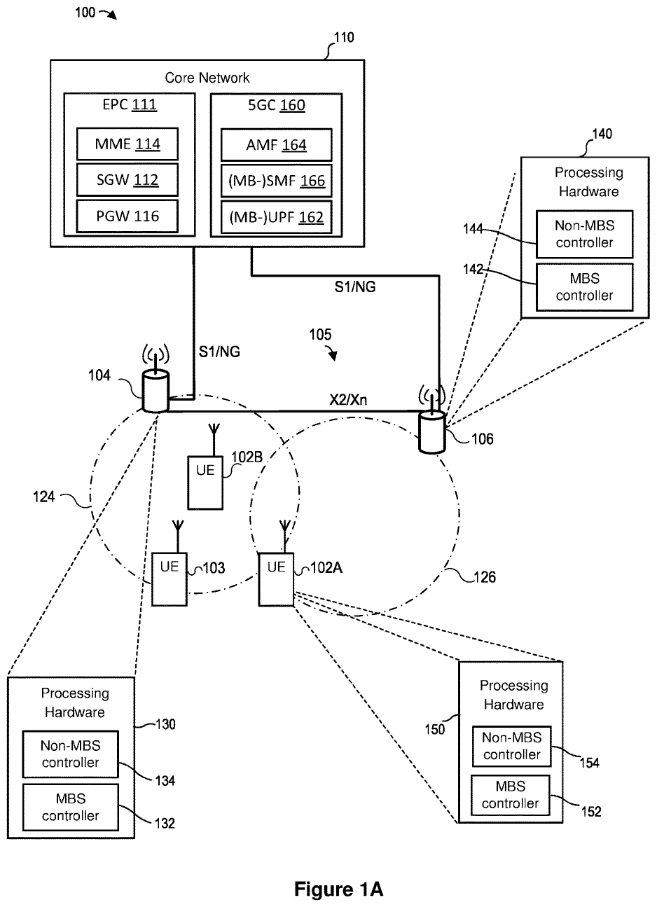

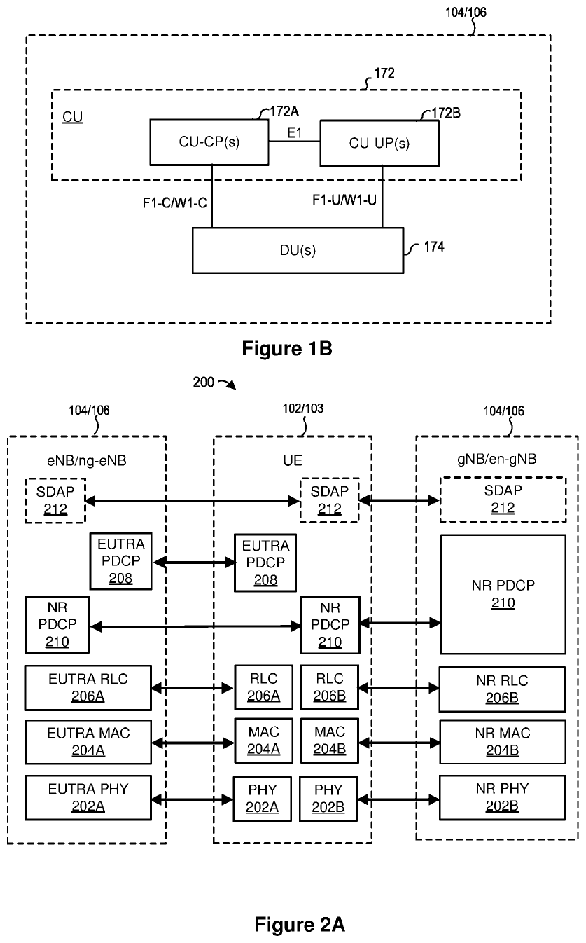

FIG. 1A depicts an example wireless communication system 100 in which techniques of this disclosure for managing transmission and reception of multicast and/or broadcast services (MBS) information can be implemented. The wireless communication system 100 includes user equipment (UEs) 102A, 102B, and 103 as well as base stations 104, 106 of a radio access network (RAN) 105 connected to a core network (CN) 110. In other implementations or scenarios, the wireless communication system 100 may instead include more or fewer UEs, and/or more or fewer base stations, than are shown in FIG. 1A. The base stations 104, 106 can be of any suitable type, or types, of base stations, such as an evolved node B (eNB), a next-generation eNB (ng-eNB), or a 5G Node B (gNB), for example. As a more specific example, the base station 104 may be an eNB or a gNB, and the base stations 106 may be a gNB.

The base station 104 supports a cell 124, and the base station 106 supports a cell 126. The cell 124 partially overlaps with the cell 126, so that the UE 102A can be in range to communicate with base station 104 while simultaneously being in range to communicate with the base station 106 (or in range to detect or measure signals from the base station 106). The overlap can make it possible for the UE 102A to hand over between the cells (e.g., from the cell 124 to the cell 126) or base stations (e.g., from the base station 104 to the base station 106) before the UE 102A experiences radio link failure, for example. Moreover, the overlap allows various dual connectivity (DC) scenarios. For example, the UE 102A can communicate in DC with the base station 104 (operating as a master node (MN)) and the base station 106 (operating as a secondary node (SN)). When the UE 102A is in DC with the base station 104 and the base station 106, the base station 104 operates as a master eNB (MeNB), a master ng-eNB (Mng-eNB), or a master gNB (MgNB), and the base station 106 operates as a secondary gNB (SgNB) or a secondary ng-eNB (Sng-eNB).

In non-MBS (unicast) operation, the UE 102A can use a radio bearer (e.g., a DRB or an SRB)) that at different times terminates at an MN (e.g., the base station 104) or an SN (e.g., the base station 106). For example, after handover or SN change to the base station 106, the UE 102A can use a radio bearer (e.g., a DRB or an SRB) that terminates at the base station 106. The UE 102A can apply one or more security keys when communicating on the radio bearer, in the uplink (from the UE 102A to a base station) and/or downlink (from a base station to the UE 102A) direction. In non-MBS operation, the UE 102A transmits data via the radio bearer on (i.e., within) an uplink (UL) bandwidth part (BWP) of a cell to the base station, and/or receives data via the radio bearer on a downlink (DL) BWP of the cell from the base station. The UL BWP can be an initial UL BWP or a dedicated UL BWP, and the DL BWP can be an initial DL BWP or a dedicated DL BWP. The UE 102A can receive paging, system information, public warning message(s), or a random access response on the DL BWP. In this non-MBS operation, the UE 102A can be in a connected state. Alternatively, the UE 102A can be in an idle or inactive state if the UE 102A supports small data transmission in the idle or inactive state.

In MBS operation, the UE 102A can use an MBS radio bearer (MRB) that at different times terminates at an MN (e.g., the base station 104) or an SN (e.g., the base station 106). For example, after handover or SN change, the UE 102A can use an MRB that terminates at the base station 106, which can be operating as an MN or SN. In some scenarios, a base station (e.g., the MN or SN) can transmit MBS data over unicast radio resources (i.e., the radio resources dedicated to the UE 102A) to the UE 102A via the MRB. In other scenarios, the base station (e.g., the MN or SN) can transmit MBS data over multicast radio resources (i.e., the radio resources common to the UE 102A and one or more other UEs), or a DL BWP of a cell from the base station to the UE 102A, via the MRB. The DL BWP can be an initial DL BWP, a dedicated DL BWP, or an MBS DL BWP (i.e., a DL BWP that is specific to MBS, or not for unicast).

The base station 104 includes processing hardware 130, which can include one or more general-purpose processors (e.g., central processing units (CPUs)) and a computer-readable memory storing machine-readable instructions executable on the one or more general-purpose processor(s), and/or special-purpose processing units. The processing hardware 130 in the example implementation of FIG. 1A includes an MBS controller 132 that is configured to manage or control transmission of MBS information received from the CN 110 or an edge server. For example, the MBS controller 132 can be configured to support radio resource control (RRC) configurations, procedures and messaging associated with MBS procedures, and/or other operations associated with those configurations and/or procedures, including a HARQ process, as discussed below. The processing hardware 130 can also include a non-MBS controller 134 that is configured to manage or control one or more RRC configurations and/or RRC procedures when the base station 104 operates as an MN or SN during a non-MBS operation.

The base station 106 includes processing hardware 140, which can include one or more general-purpose processors (e.g., CPUs) and a computer-readable memory storing machine-readable instructions executable on the general-purpose processor(s), and/or special-purpose processing units. The processing hardware 140 in the example implementation of FIG. 1A includes an MBS controller 142 and a non-MBS controller 144, which may be similar to the controllers 132 and 134, respectively, of base station 130. Although not shown in FIG. 1A, the RAN 105 can include additional base stations with processing hardware similar to the processing hardware 130 of the base station 104 and/or the processing hardware 140 of the base station 106.

The UE 102A includes processing hardware 150, which can include one or more general-purpose processors (e.g., CPUs) and a computer-readable memory storing machine-readable instructions executable on the general-purpose processor(s), and/or special-purpose processing units. The processing hardware 150 in the example implementation of FIG. 1A includes an MBS controller 152 that is configured to manage or control reception of MBS information. For example, the UE MBS controller 152 can be configured to support RRC configurations, procedures and messaging associated with MBS procedures, and/or other operations associated with those configurations and/or procedures, including a HARQ process, as discussed below. The processing hardware 150 can also include a non-MBS controller 154 configured to manage or control one or more RRC configurations and/or RRC procedures in accordance with any of the implementations discussed below, when the UE 102A communicates with an MN and/or an SN during a non-MBS operation. Although not shown in FIG. 1A, UEs 102B and 103 may include processing hardware similar to the processing hardware 150 of the UE 102A.

The CN 110 may be an evolved packet core (EPC) 111 or a fifth-generation core (5GC) 160, both of which are depicted in FIG. 1A. The base station 104 may be an eNB supporting an S1 interface for communicating with the EPC 111, an ng-eNB supporting an NG interface for communicating with the 5GC 160, or a gNB that supports an NR radio interface as well as an NG interface for communicating with the 5GC 160. The base station 106 may be an EUTRA-NR DC (EN-DC) gNB (en-gNB) with an S1 interface to the EPC 111, an en-gNB that does not connect to the EPC 111, a gNB that supports the NR radio interface and an NG interface to the 5GC 160, or a ng-eNB that supports an EUTRA radio interface and an NG interface to the 5GC 160. To directly exchange messages with each other during the scenarios discussed below, the base stations 104 and 106 may support an X2 or Xn interface.

Among other components, the EPC 111 can include a serving gateway (SGW) 112, a mobility management entity (MME) 114, and a packet data network gateway (PGW) 116. The SGW 112 is generally configured to transfer user-plane packets related to audio calls, video calls, Internet traffic, etc., and the MME 114 is configured to manage authentication, registration, paging, and other related functions. The PGW 116 provides connectivity from a UE (e.g., UE 102A or 102B) to one or more external packet data networks, e.g., an Internet network and/or an Internet Protocol (IP) Multimedia Subsystem (IMS) network. The 5GC 160 includes a user plane function (UPF) 162 and an access and mobility management (AMF) 164, and/or a session management function (SMF) 166. The UPF 162 is generally configured to transfer user-plane packets related to audio calls, video calls, Internet traffic, etc., the AMF 164 is generally configured to manage authentication, registration, paging, and other related functions, and the SMF 166 is generally configured to manage PDU sessions.

The UPF 162, AMF 164, and/or SMF 166 can be configured to support MBS. For example, the SMF 166 can be configured to manage or control MBS transport, configure the UPF 162 and/or RAN 105 for MBS flows, and/or manage or configure one or more MBS sessions or PDU sessions for MBS for a UE (e.g., UE 102A or 102B). The UPF 162 is configured to transfer MBS data packets to audio, video, Internet traffic, etc. to the RAN 105. The UPF 162 and/or SMF 166 can be configured for both non-MBS unicast service and MBS, or for MBS only.

Generally, the wireless communication system 100 may include any suitable number of base stations supporting NR cells and/or EUTRA cells. More particularly, the EPC 111 or the 5GC 160 may be connected to any suitable number of base stations supporting NR cells and/or EUTRA cells. Although the examples below refer specifically to specific CN types (EPC, 5GC) and RAT types (5G NR and EUTRA), in general the techniques of this disclosure can also apply to other suitable radio access and/or core network technologies, such as sixth generation (6G) radio access and/or 6G core network or 5G NR-6G DC, for example.

In different configurations or scenarios of the wireless communication system 100, the base station 104 can operate as an MeNB, an Mng-eNB, or an MgNB, and the base station 106 can operate as an SgNB or an Sng-eNB. The UE 102A can communicate with the base station 104 and the base station 106 via the same radio access technology (RAT), such as EUTRA or NR, or via different RATs.

When the base station 104 is an MeNB and the base station 106 is an SgNB, the UE 102A can be in EN-DC with the MeNB 104 and the SgNB 106. When the base station 104 is an Mng-eNB and the base station 106 is an SgNB, the UE 102A can be in next generation (NG) EUTRA-NR DC (NGEN-DC) with the Mng-eNB 104 and the SgNB 106. When the base station 104 is an MgNB and the base station 106 is an SgNB, the UE 102A can be in NR-NR DC (NR-DC) with the MgNB 104 and the SgNB 106. When the base station 104 is an MgNB and the base station 106 is an Sng-eNB, the UE 102A can be in NR-EUTRA DC (NE-DC) with the MgNB 104 and the Sng-eNB 106.

FIG. 1B depicts an example distributed implementation of any one or more of the base stations 104 and 106. In this implementation, the base station 104 or 106 includes a central unit (CU) 172 and one or more distributed units (DUs) 174. The CU 172 includes processing hardware, such as one or more general-purpose processors (e.g., CPUs) and a computer-readable memory storing machine-readable instructions executable on the general-purpose processor(s), and/or special-purpose processing units. For example, the CU 172 can include some or all of the processing hardware 130 or 140 of FIG. 1A.

Each of the DUs 174 also includes processing hardware that can include one or more general-purpose processors (e.g., CPUs) and computer-readable memory storing machine-readable instructions executable on the one or more general-purpose processors, and/or special-purpose processing units. For example, the processing hardware can include a medium access control (MAC) controller configured to manage or control one or more MAC operations or procedures (e.g., a random access procedure), and a radio link control (RLC) controller configured to manage or control one or more RLC operations or procedures when the base station (e.g., base station 104) operates as an MN or an SN. The processing hardware can also include a physical (PHY) layer controller configured to manage or control one or more PHY layer operations or procedures.

In some implementations, the CU 172 can include one or more logical nodes (CU-CP(s) 172A) that host the control plane part of the Packet Data Convergence Protocol (PDCP) protocol of the CU 172 and/or the radio resource control (RRC) protocol of the CU 172. The CU 172 can also include one or more logical nodes (CU-UP(s) 172B) that host the user plane part of the PDCP protocol and/or service data adaptation protocol (SDAP) protocol of the CU 172. The CU-CP(s) 172A can transmit non-MBS control information and MBS control information, and the CU-UP(s) 172B can transmit non-MBS data packets and MBS data packets, as described herein.

The CU-CP(s) 172A can be connected to multiple CU-UPs 172B through the E1 interface. The CU-CP(s) 172A select the appropriate CU-UP(s) 172B for the requested services for the UE 102A. In some implementations, a single CU-UP 172B can be connected to multiple CU-CPs 172A through the E1 interface. A CU-CP 172A can be connected to one or more DUs 174s through an F1-C interface. A CU-UP 172B can be connected to one or more DUs 174 through an F1-U interface under the control of the same CU-CP 172A. In some implementations, one DU 174 can be connected to multiple CU-UPs 172B under the control of the same CU-CP 172A. In such implementations, the connectivity between a CU-UP 172B and a DU 174 is established by the CU-CP 172A using bearer context management functions.

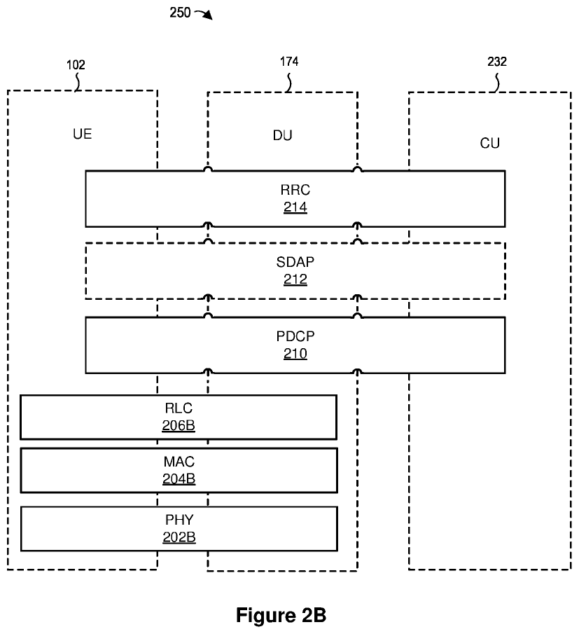

FIG. 2A illustrates, in a simplified manner, an example protocol stack 200 according to which a UE (e.g., UE 102A, 102B, or 103) can communicate with an eNB/ng-eNB or a gNB (e.g., one or more of the base stations 104, 106). In the example protocol stack 200, a PHY sublayer 202A of EUTRA provides transport channels to an EUTRA MAC sublayer 204A, which in turn provides logical channels to an EUTRA RLC sublayer 206A. The EUTRA RLC sublayer 206A in turn provides RLC channels to an EUTRA PDCP sublayer 208 and, in some cases, to an NR PDCP sublayer 210. Similarly, an NR PHY 202B provides transport channels to an NR MAC sublayer 204B, which in turn provides logical channels to an NR RLC sublayer 206B. The NR RLC sublayer 206B in turn provides RLC channels to an NR PDCP sublayer 210. The UE 102A, in some implementations, supports both the EUTRA and the NR stack as shown in FIG. 2A, to support handover between EUTRA and NR base stations and/or to support DC over EUTRA and NR interfaces. Further, as illustrated in FIG. 2A, the UE 102A can support layering of NR PDCP 210 over EUTRA RLC 206A, and an SDAP sublayer 212 over the NR PDCP sublayer 210. Sublayers are also referred to herein as simply “layers.”

The EUTRA PDCP sublayer 208 and the NR PDCP sublayer 210 receive packets (e.g., from an IP layer, layered directly or indirectly over the PDCP layer 208 or 210) that can be referred to as service data units (SDUs), and output packets (e.g., to the RLC layer 206A or 206B) that can be referred to as protocol data units (PDUs). Except where the difference between SDUs and PDUs is relevant, this disclosure for simplicity refers to both SDUs and PDUs as “packets.” The packets can be MBS packets or non-MBS packets. MBS packets may include application content for an MBS service (e.g., IPv4/IPv6 multicast delivery, IPTV, software delivery over wireless, group communications, IoT applications, V2X applications, and/or emergency messages related to public safety), for example. As another example, MBS packets may include application control information for the MBS service.

On a control plane, the EUTRA PDCP sublayer 208 and the NR PDCP sublayer 210 can provide SRBs to exchange RRC messages or non-access-stratum (NAS) messages, for example. On a user plane, the EUTRA PDCP sublayer 208 and the NR PDCP sublayer 210 can provide DRBs to support data exchange. Data exchanged on the NR PDCP sublayer 210 may be SDAP PDUs, IP packets, or Ethernet packets, for example.

In scenarios where the UE 102A, 102B, or 103 operates in EN-DC with the base station 104 operating as an MeNB and the base station 106 operating as an SgNB, the wireless communication system 100 can provide the UE 102A, 102B, or 103 with an MN-terminated bearer that uses EUTRA PDCP sublayer 208, or an MN-terminated bearer that uses NR PDCP sublayer 210. The wireless communication system 100 in various scenarios can also provide the UE 102A, 102B, or 103 with an SN-terminated bearer, which uses only the NR PDCP sublayer 210. The MN-terminated bearer may be an MCG bearer, a split bearer, or an MN-terminated SCG bearer. The SN-terminated bearer may be an SCG bearer, a split bearer, or an SN-terminated MCG bearer. The MN-terminated bearer may be an SRB (e.g., SRB1 or SRB2) or a DRB. The SN-terminated bearer may be an SRB or a DRB.

In some implementations, a base station (e.g., base station 104, 106) broadcasts or multicasts MBS data packets via one or more MBS radio bearers (MRB(s)), and in turn the UE 102A, 102B, or 103 receives the MBS data packets via the MRB(s). The base station can include configuration(s) of the MRB(s) in multicast configuration parameters (which can also be referred to as MBS configuration parameters) described below. In some implementations, the base station broadcasts the MBS data packets via RLC sublayer 206, MAC sublayer 204, and PHY sublayer 202, and correspondingly, the UE 102A uses PHY sublayer 202, MAC sublayer 204, and RLC sublayer 206 to receive the MBS data packets. In such implementations, the base station and the UE 102A, 102B, or 103 may not use PDCP sublayer 208 and a SDAP sublayer 212 to communicate the MBS data packets. In other implementations, the base station transmits the MBS data packets via PDCP sublayer 208, RLC sublayer 206, MAC sublayer 204, and PHY sublayer 202, and correspondingly, the UE 102A, 102B, or 103 uses PHY sublayer 202, MAC sublayer 204, RLC sublayer 206 and PDCP sublayer 208 to receive the MBS data packets. In such implementations, the base station and the UE 102A, 102B, or 103 may not use a SDAP sublayer 212 to communicate the MBS data packets. In yet other implementations, the base station transmits the MBS data packets via the SDAP sublayer 212, PDCP sublayer 208, RLC sublayer 206, MAC sublayer 204, and PHY sublayer 202 and, correspondingly, the UE 102A, 102B, or 103 uses the PHY sublayer 202, MAC sublayer 204, RLC sublayer 206, PDCP sublayer 208, and SDAP sublayer 212 to receive the MBS data packets.

FIG. 2B illustrates, in a simplified manner, an example protocol stack 250 that the UE 102A, 102B, or 103 can use to communicate with a DU (e.g., DU 174) and a CU (e.g., CU 172). The radio protocol stack 200 of FIG. 2A is functionally split as shown by the radio protocol stack 250 in FIG. 2B. The CU at any of the base stations 104 or 106 can hold all the control and upper layer functionalities (e.g., RRC 214, SDAP 212, NR PDCP 210), while the lower layer operations (e.g., NR RLC 206B, NR MAC 204B, and NR PHY 202B) can be delegated to the DU. To support connection to a 5GC, NR PDCP 210 provides SRBs to RRC 214, and NR PDCP 210 provides DRBs to SDAP 212 and SRBs to RRC 214.

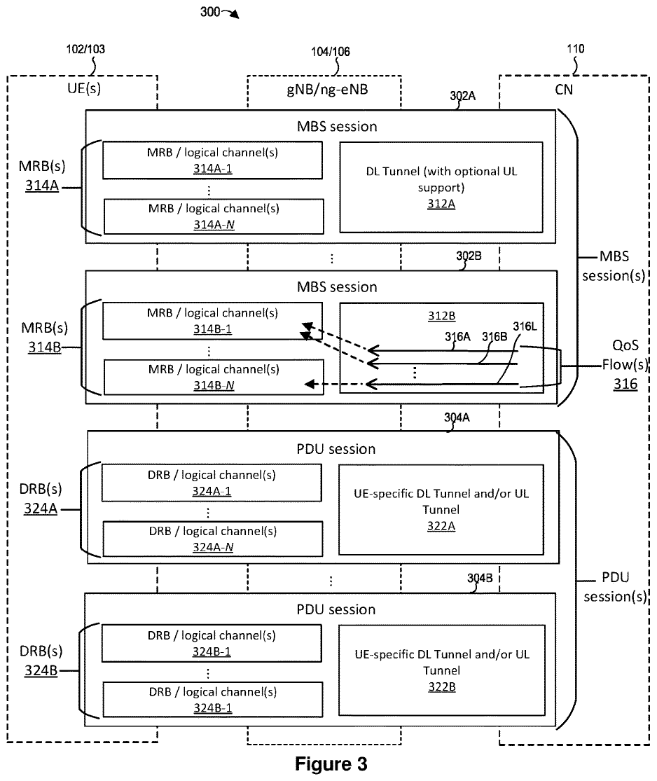

Referring to FIG. 3, an MBS session 302A can include a tunnel 312A with endpoints at the CN 110 and the base station 104/106. The MBS session 302A can correspond to a certain session ID such as a Temporary Mobile Group Identity (TMGI), for example. The MBS data can include IP packets, TCP/IP packets, UDP/IP packets, Real-Time Transport Protocol (RTP)/UDP/IP packets, or RTP/TCP/IP packets, for example.

In some cases, the CN 110 and/or the base station 104/106 configure the tunnel 312A only for MBS traffic directed from the CN 110 to the base station 104/106, and the tunnel 312A can be referred to as a downlink (DL) tunnel. In other cases, however, CN 110 and the base station 104/106 use the tunnel 312A for downlink as well as for uplink (UL) MBS traffic to support, for example, commands or service requests from the UEs. Further, because the base station 104/106 can direct MBS traffic arriving via the tunnel 312A to multiple UEs, the tunnel 312A can be referred to as a common tunnel or a common DL tunnel.

The tunnel 312A can operate at the transport layer or sublayer, e.g., on the User Datagram Protocol (UDP) protocol layered over Internet Protocol (IP). As a more specific example, the tunnel 312A can be associated with the General Packet Radio System (GPRS) Tunneling Protocol (GTP). The tunnel 312A can correspond to a certain IP address (e.g., an IP address of the base station 104/106) and a certain Tunnel Endpoint Identifier (TEID) (e.g., assigned by the base station 104/106), for example. More generally, the tunnel 312A can have any suitable transport-layer configuration. The CN 110 can specify the IP address and the TEID address in header(s) of a tunnel packet including an MBS data packet, and transmit the tunnel packet downstream to the base station 104/106 via the tunnel 312A (i.e., the header(s) can include the IP address and/or the TEID). For example, the header(s) can include an IP header and a GTP header including the IP address and the TEID, respectively. The base station 104/106 accordingly can identify data packets traveling via the tunnel 312A using the IP address and/or the TEID.

As illustrated in FIG. 3, the base station 104/106 maps traffic in the tunnel 312A to N radio bearers 314A-1, 314A-2, . . . 314A-N, which may be configured as MBS radio bearers or MRBs, where N≥1. Each MRB can correspond to a respective logical channel. As discussed above, the PDCP sublayer provides support for radio bearers such as SRBs, DRBs, and MRBs, and a EUTRA or NR MAC sublayer provides logical channels to a EUTRA or NR RLC sublayer. Each of the MRBs 314A for example can correspond to a respective MBS Traffic Channel (MTCH). The base station 104/106 and the CN 110 can also maintain another MBS session 302B, which similarly can include a tunnel 312B corresponding to MRBs 314B-1, 314B-2, . . . 314B-N, where N≥1. Each of the MRBs 314B can correspond to a respective logical channel.

The MBS traffic can include one or multiple quality-of-service (QoS) flows, for each of the tunnels 312A, 312B, etc. For example, the MBS traffic on the tunnel 312B can include a set of flows 316 including QoS flows 316A, 316B, . . . 316L. Further, a logical channel of an MRB can support a single QoS flow or multiple QoS flows. In the example configuration of FIG. 3, the base station 104/106 maps the QoS flows 316A and 316B to the MTCH of the MRB 314B-1, and the QoS flow 316L to the MTCH of the MRB 314B-N.

In various scenarios, the CN 110 can assign different types of MBS traffic to different QoS flows. A flow with a relatively high QoS value can correspond to audio packets, and a flow with a relatively low QoS value can correspond to video packets, for example. As another example, a flow with a relatively high QoS value can correspond to I-frames or complete images used in video compression, and a flow with a relatively low QoS value can correspond to P-frames or predicted pictures that include only changes to I-frames.

With continued reference to FIG. 3, the base station 104/106 and the CN 110 can maintain one or more PDU sessions to support unicast traffic between the CN 110 and particular UEs. A PDU session 304A can include a UE-specific DL tunnel and/or UE-specific UL tunnel 322A corresponding to one or more DRBs 324A, such as a DRB 324A-1, 324A-2, . . . 324-N. Each of the DRBs 324A can correspond to a respective logical channel, such as a Dedicated Traffic Channel (DTCH).

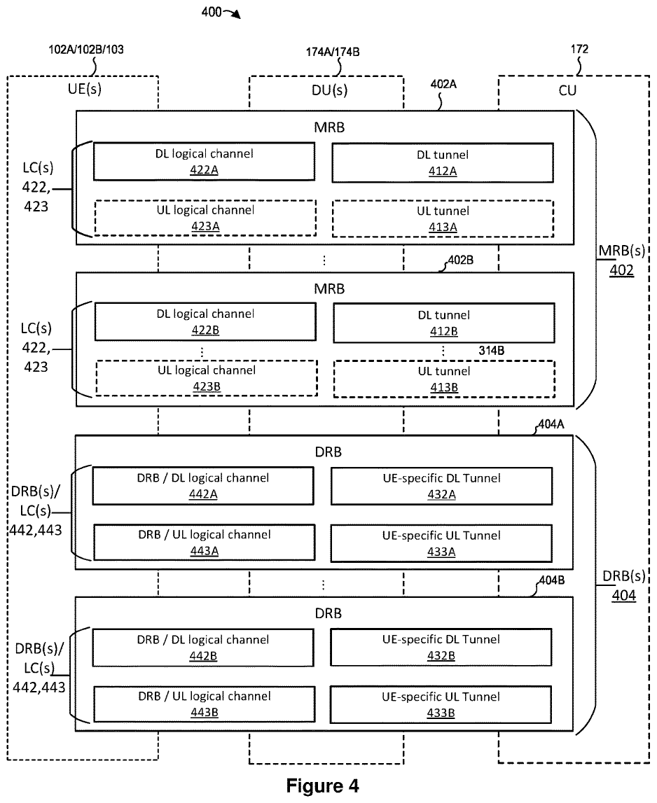

Now referring to FIG. 4, when the base station 104/106 is implemented in a distributed manner, the CU 172 and the DU 174A/174B can establish tunnels for downlink data and/or uplink data associated with an MRB or a DRB. The MRB 314A-1 discussed above can be implemented as an MRB 402A connecting the CU 172 to multiple UEs such as the UE 102A and 102B, for example. The MRB 402A can include a DL tunnel 412A connecting the CU 172 and the DU 174A/174B, and a DL logical channel 422A corresponding to the DL tunnel 412A. In particular, the DU 174A/174B can map downlink traffic received via the DL tunnel 412A to the DL logical channel 422A, which can be an MTCH or a DTCH, for example. The DL tunnel 412A can be a common DL tunnel via which the CU 172 transmits MBS data packets to multiple UEs. Alternatively, the DL tunnel 412A can be a UE-specific DL tunnel via which the CU 172 transmits MBS data packets to a particular UE.

Optionally, the MRB 402A also includes a UL tunnel 413A connecting the CU 172 and the DU 174A/174B, and a UL logical channel 423A corresponding to the UL tunnel 413A. The UL logical channel 423A can be a DTCH, for example. The DU 174A/174B can map uplink traffic received via the UL logical channel 423A to the UL tunnel 413A.

The tunnels 412A and 413A can operate at the transport layer or sublayer of the F1-U interface. As a more specific example, the CU 172 and the DU 174A/174B can utilize an F1-U for user-plane traffic, and the tunnels 412A and 413A can be associated with the GTP-U protocol layered over UDP/IP, where IP is layered over suitable data link and physical (PHY) layers. Further, the MRB(s) 402 and/or the DRB(s) 404 in at least some of the cases additionally support control-plane traffic. More particularly, the CU 172 and the DU 174A/174B can exchange F1-AP messages over an F1-C interface that relies on a Stream Control Transmission Protocol (SCTP) layered over IP, where IP is layered over suitable data link and PHY layers similar to F1-U.

Similarly, an MRB 402B can include a DL tunnel 412B and, optionally, an UL tunnel 413B. The DL tunnel 412B can correspond to a DL logical channel 422B, and the UL tunnel 413B can correspond to the UL logical channel 423B.

The CU 172 in some cases uses a DRB 404A to transmit MBS data packets or unicast data packets associated with a PDU session, to a particular UE (e.g., the UE 102A or the UE 102B). The DRB 404A can include a UE-specific DL tunnel 432A connecting the CU 172 and the DU 174A/174B, and a DL logical channel 442A corresponding to the DL tunnel 432A. In particular, the DU 174A/174B can map downlink traffic received via the DL tunnel 432A to the DL logical channel 442A, which can be a DTCH, for example. The DRB 404A further includes a UE-specific UL tunnel 433A connecting the CU 172 and the DU 174A/174B, and a UL logical channel 443A corresponding to the UL tunnel 433A. The UL logical channel 443A can be a PUSCH, for example. The DU 174A/174B can map uplink traffic received via the UL logical channel 443 A to the UL tunnel 433A.

Similarly, a DRB 404B can include a UE-specific DL tunnel 432B corresponding to a DL logical channel 442B, and a UE-specific UL tunnel 433B corresponding to a UL logical channel 443B.

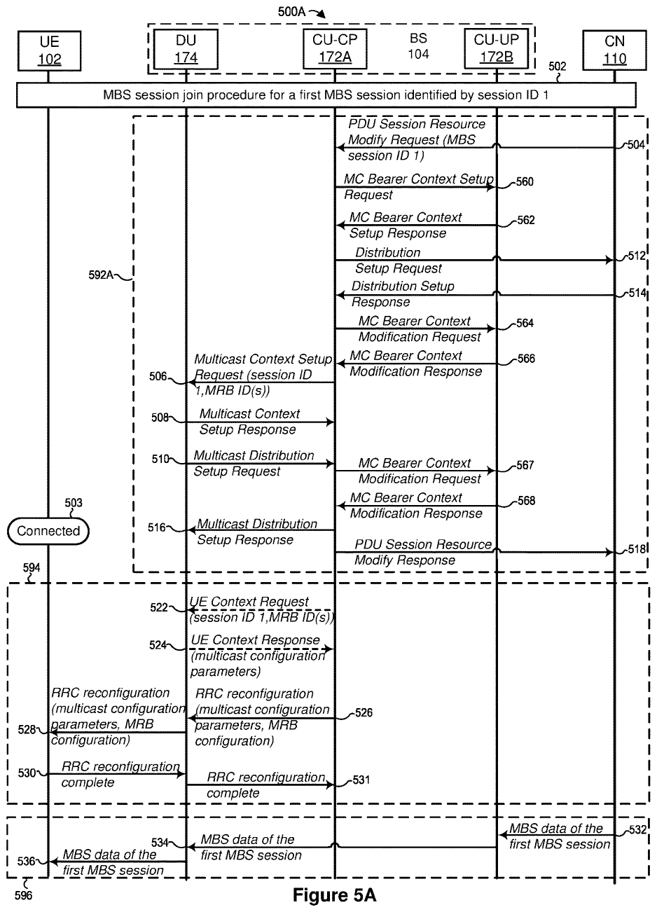

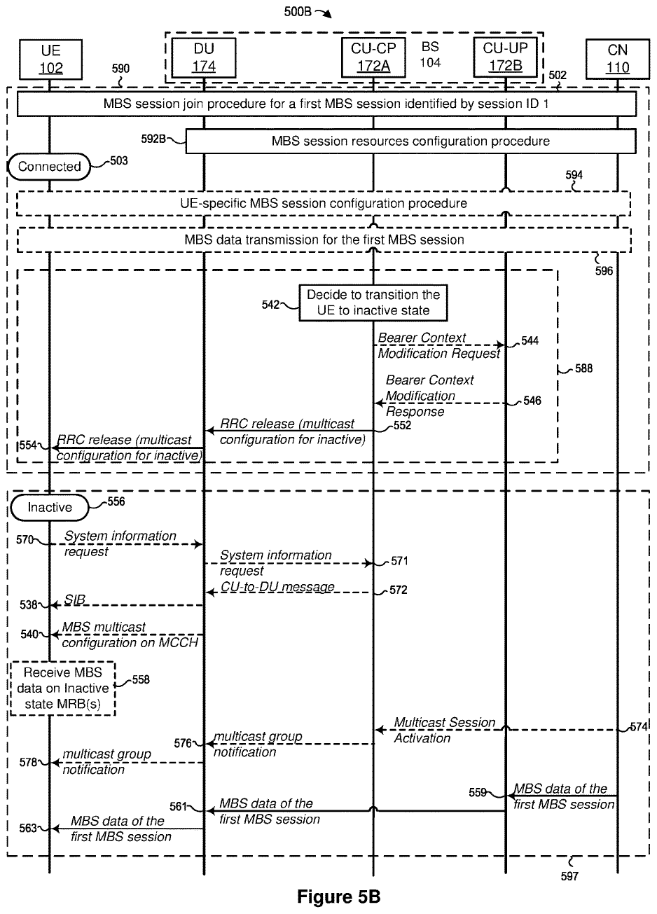

Next, several example scenarios in which a UE and/or a RAN perform the techniques of this disclosure for supporting MBS for the UE operating in a connected state and/or inactive state are discussed with reference to FIGS. 5A-5E, 6A-6C and 7A-7D. In the following description, the connected state, inactive state and idle state can be RRC_CONNECTED state, RRC_INACITVE state and RRC_IDLE state, respectively, for example.

FIG. 5A illustrates an example scenario 500A of establishing an MBS session. The base station 104 includes a DU 174, CU-CP 172A and CU-UP 172B. The scenario 500A can also apply to an integrated CU, which is not split into CP and UP function nodes.

The UE 102 (e.g., UE 102A of FIG. 1A) initially performs 502 an MBS session join procedure with the CN 110 via the base station 104 to join a first MBS session. In some implementations, the MBS session join procedure does not involve the CU-UP 172B. In other implementations, in case of NG-U multicast transport, the CU-UP 172B joins the NG-U multicast group by sending IGMP/MLD join request(s) to the CN 110. In some scenarios, the UE 102 subsequently performs an additional one or more MBS join procedures, and event 502 accordingly is a first one of multiple MBS join procedures. Because the base station 104 configures a common DL tunnel for MBS traffic (rather than a UE-specific tunnel as discussed below), the procedures 502 and 592A can occur in either order. In other words, the base station 104 can configure a common DL tunnel before even a single UE joins the first MBS session.

In some implementations, the UE 102 performs 502 the MBS session join procedure while operating in a connected state. In some scenarios or implementations, if the first MBS session has not started yet, the CU-CP 172A transitions the UE 102 to an inactive state or idle state after the MBS session join procedure to save battery power of the UE 102. For example, the CU-CP 172A can transmit an RRC release message to the UE 102 to transition the UE 102 to the inactive state or idle state from the connected state. The UE 102 transitions to the inactive state or idle state in response to the RRC release message. In the case of the inactive state, the UE 102 later can initiate am RRC connection resume procedure with the CU-CP 172A via the DU 174 to transition to the connected state. In response to the initiation, the UE 102 transmits an RRC resume request message to the CU-CP 172A via the DU 174 and receives an RRC resume message from the CU-CP 172A via the DU 174. In response, the UE 102 transitions 503 to the connected state and transmits an RRC resume complete message to the CU-CP 172A via the DU 174. In the case of the idle state, the UE 102 later can initiate an RRC connection establishment procedure with the CU-CP 172A via the DU 174 to transition to the connected state. In response to the initiation, the UE 102 transmits an RRC setup request message to the CU-CP 172A via the DU 174 and receives an RRC setup message from the CU-CP 172A via the DU 174. In response, the UE 102 transitions 503 to the connected state and transmits an RRC setup complete message to the CU-CP 172A via the DU 174.

Otherwise, if the first MBS session has started, is in the process of starting, or is about to start, the CU-CP 172A remains the UE 102 in the connected state.

While the UE 102 operates in the connected state, the UE 102 monitors a PDCCH with a cell radio network temporary identifier (C-RNTI) to communicate unicast data with the DU 174. In some implementations, the unicast data include data associated with SRB(s) and/or DRB(s). In one implementation, the unicast data includes the messages of the MBS session join procedure and the messages associated with events 528 and 530 described below. In some implementations, the unicast data also includes unicast MBS data (e.g., event 536). In other implementations, the unicast data excludes multicast MBS data (e.g., event 536). In one implementation, when the UE 102 receives a DCI and a (scrambled) CRC on a PDCCH, the UE 102 uses the C-RNTI and DCI to verify the (scrambled) CRC. If the UE 102 verifies the (scrambled) CRC is valid and the DCI includes a UL grant, the UE 102 transmits a UL transmission including unicast data to the DU 174 in accordance with the UL grant. If the UE 102 verifies the (scrambled) CRC is valid and the DCI includes a DL assignment, the UE 102 receives a DL transmission including unicast data from the DU 174 in accordance with the DL assignment.

To perform the MBS session join procedure, the UE 102 in some implementations sends an MBS session join request message to the CN 110 via the base station 104. In response, the CN 110 can send an MBS session join response message to the UE 102 via the base station 104 to grant the UE 102 access to the first MBS session. In some implementations, the UE 102 can include a first MBS session ID (e.g., MBS Session ID 1) for the first MBS session in the MBS session join request message. The CN 110 in some cases includes the first MBS session ID in the MBS session join response message. In some implementations, the UE 102 can send an MBS session join complete message to the CN 110 via the base station 104 in response to the MBS session join response message.

In some implementations, the MBS session join request message, MBS session join response message, and MBS session join complete message can be session initiation protocol (SIP) messages. In other implementations, the MBS session join request message, MBS session join response message, and MBS session join complete message can be NAS messages such as 5G mobility management (5GMM) messages or 5G session management messages (5GSM). In the case of the 5GSM messages, the UE 102 can transmit to the CN 110 via the base station 104 a (first) UL container message including the MBS session join request message, the CN 110 can transmit to the UE 102 via the base station 104 a DL container message including the MBS session join response message, and the UE 102 can transmit to the CN 110 via the base station 104 a (second) UL container message including the MBS session join complete message. These container messages can be 5GMM messages. In some implementations, the MBS session join request message, MBS session join response, and MBS session join complete message can be a PDU Session Modification Request message, a PDU Session Modification Command message, and a PDU Session Modification Complete message, respectively. To simplify the following description, the terms MBS session join request message, MBS session join response message, and/or MBS session join complete message can represent either the respective container messages, or the respective messages without containers.

In some implementations, the UE 102 can perform a PDU session establishment procedure with the CN 110 via the base station 104 to establish a PDU session in order to perform the (first) MBS session join procedure. During the PDU session establishment procedure, the UE 102 can communicate a PDU session ID of the PDU session with the CN 110 via the base station 104.

Before, during, or after the first MBS session join procedure (event 502), if the first MBS session is currently active and no multicast MBS session context is yet established in the BS 104, the CN 110 can send 504 a first CN-to-BS message (e.g., PDU Session Resource Modify Request or Multicast Session Activation Request message) including the first MBS session ID to the CU-CP 172A to request the CU-CP 172A to configure or activate resources for the first MBS session (i.e., a multicast (MBS) session).

In some implementations, the CN 110 can include first MBS quality of service (QoS) flow configuration(s) for the first MBS session in the first CN-to-BS message. In some implementations, the first MBS QoS flow configuration(s) configures MBS QoS flow(s) 1, . . . , M associated with the first MBS session. Mis an integer and larger than zero. In some implementations, the first MBS QoS flow configuration(s) include MBS QoS flow identifier(s) 1, . . . , M and/or MBS QoS flow level QoS parameter(s) 1, . . . , M for the MBS QoS flow(s) 1, . . . , M associated with the first MBS session, respectively. In some implementations, each of the MBS QoS flow configuration(s) 1, . . . , M includes an MBS QoS flow identifier and MBS QoS flow level QoS parameters for a particular MBS QoS flow.

In other implementations, the CN 110 does not include MBS QoS flow configuration(s) for the first MBS session in the first CN-to-BS message. Thus, the CU-CP 172A generates the second MBS QoS flow configuration(s) based on preconfigured MBS QoS flow configuration(s). For example, the second MBS QoS flow configuration(s) are the same as the preconfigured MBS QoS flow configuration(s). In another example, the second MBS QoS flow configuration(s) are similar to the preconfigured MBS QoS flow configuration(s). In some implementations, the CU-CP 172A can be preconfigured with the preconfigured MBS QoS flow configuration(s) before receiving the first CN-to-BS message. In other implementations, the CU-CP 172A can receive the preconfigured MBS QoS flow configuration(s) from an Operations, Administration and Maintenance (OAM) node before receiving the first CN-to-BS message. Examples or implementations described for the first MBS QoS flow configuration(s) can apply to the preconfigured MBS QoS flow configuration(s). In yet another implementations, the CN 110 includes MBS QoS flow configuration(s) for the first MBS session in the second CN-to-BS message (e.g., Distribution Setup Response message).

In some implementations, the CN 110 can include, in the first CN-to-BS message, first slice information indicating a network slice used for the first MBS session. For example, the first slice information can be Single Network Slice Selection Assistance Information (S-NSSAI) identifying the particular network slice. In other implementations, the CN 110 does not include slice information (e.g., S-NSSAI) in the first CN-to-BS message. In such cases, a default network slice may be used for the first MBS session.

In some implementations, the CN 110 can include, in the first CN-to-BS message, first MBS area information (e.g., MBS Service Area IE) configuring or indicating MBS area(s) for the first MBS session. In cases where the first MBS session is a location dependent multicast session, the first MBS area information includes one or more tuples of {MBS Area Session ID IE, MBS Service Area Information IE}. In cases where the first MBS session is a location independent multicast session, the first MBS are information includes an MBS Service Area Information IE. A MBS Service Area Information IE in the first MBS area information includes a list of cell identity/identities and/or a list of tracking area identity/identities (TAI(s)). In one implementation, the cell identity/identities is/are cell global identity/identities (CGI(s)). In other implementations, the CN 110 does not include MBS area information (e.g., MBS Service Area IE) in the first CN-to-BS message.

After receiving 504 the first CN-to-BS message, the CU-CP 172A sends 560 to the CU-UP 172B a first CP-to-UP message (e.g., MC Bearer Context Setup Request message) to request establishing resources for the first MBS session at the CU-UP 172B. In some implementations, the CU-CP 172A determines to configure one or more MRBs for the first MBS session or the MBS QoS flow(s) 1, . . . , M. In response to the determination, the CU-CP 172A generates a MRB setup configuration for requesting resources for the one or more MRBs. The CU-CP 172A includes the first MBS session ID, the MRB setup configuration and/or second MBS QoS flow configuration(s) for the first MBS session in the first CP-to-UP message. In some implementations, the second MBS QoS flow configuration(s) include QoS parameters for the MBS QoS flow(s) associated with the first MBS session. In some implementations, the QoS parameters include 5G QoS identifier(s) (5QI(s)), priority level(s), packet delay budget(s), packet error rate(s), averaging window(s), and/or maximum data burst volume(s), for example.

In some implementations, the CU-CP 172A can include the second MBS QoS flow configuration(s) (e.g., MBS QoS flows Information to be Setup and/or MRB QoS IE(s), or QoS-Flow-QoS-Parameter-List and/or QoSFlowLevelQoSParameters IE(s)) in the MRB setup configuration (e.g., MCMRBSetupConfiguration IE). In some implementations, the MRB setup configuration includes one or more MRB setup configuration item(s) (e.g. MCMRBSetupConfiguration-Item IE(s)). In some implementations, each of the MRB setup configuration item(s) includes a MRB ID, MRB configuration parameters (e.g., a PDCP configuration and/or a SDAP configuration), and/or particular one(s) of the second MBS QoS flow configuration(s) for a particular MRB. In some implementations, the PDCP configuration includes a UL PDCP sequence number size configuration, a DL PDCP sequence number size configuration and/or a RLC mode configuration (e.g., acknowledged mode or unacknowledged mode). In some implementations, the SDAP configuration includes a default DRB configuration (e.g., DefaultDRB IE), a SDAP UL header configuration (e.g., SDAP-Header-UL) and/or a SDAP DL header configuration (e.g., SDAP-Header-DL).

In some implementations, the second MBS QoS flow configuration(s) include QoS parameters required for each of the MBS QoS flow(s) associated with the MRB(s). In some implementations, the second MBS QoS flow configuration(s) include MBS QoS flow identifier(s) 1, . . . , M and/or MBS QoS flow level QoS parameter(s) 1, . . . , M for the MBS QoS flow(s) 1, . . . , M associated with the first MBS session, respectively. The MBS QoS flow identifier(s) 1, . . . , M identify the MBS QoS flow(s) 1, . . . , M, respectively. For example, the MRB setup configuration includes MRB setup configuration item(s) 1, . . . , N for the MRB(s) 1, . . . , N, respectively. Nis an integer and larger than zero. In the MRB setup configuration, the CU-CP 172A can configure mapping(s) or association(s) between the MBS QoS flow(s) 1, . . . , M and MRB(s) 1, . . . , N, where Nis an integer and M≥N>0. In some implementations, the CU-CP 172A associates or maps a particular QoS flow to only a particular MRB. In other words, the CU-CP 172A refrains from associating or mapping a particular QoS flow to two MRBs. In some implementations, the MRB setup configuration item X includes MRB ID X, PDCP configuration X, SDAP configuration X, and/or particular MBS QoS flow configuration(s) of the second MBS QoS flow configuration(s), for MRB X of the MRB(s) 1, . . . , N, where 1≤X≤N.

Example 1 of the MRB setup configuration:

MCMRBSetupConfiguration ::= SEQUENCE (SIZE(1..maxnoofMRBs)) OF
MCMRBSetupConfiguration-Item
MCMRBSetupConfiguration-Item ::= SEQUENCE {

| | |
|---|---|
| mrb-ID | MRB-ID, |
| sdap-config | SDAP-Configuration, |
| mbs-pdcp-config | PDCP-Configuration, |
| qoS-Flow-QoS-Parameter-List | QoS-Flow-QoS-Parameter-List, |
| qoSFlowLevelQoSParameters | QoSFlowLevelQoSParameters OPTIONAL, |

```
  iE-Extensions ProtocolExtensionContainer { {MCMRBSetupConfiguration-
Item-ExtIEs} } OPTIONAL,
  ...
}
```

Example 2 of the MRB setup configuration (i.e., SDAP-Configuration is omitted):

MCMRBSetupConfiguration ::= SEQUENCE (SIZE(1..maxnoofMRBs)) OF
MCMRBSetupConfiguration-Item
MCMRBSetupConfiguration-Item ::= SEQUENCE {

| | |
|---|---|
| mrb-ID | MRB-ID, |
| mbs-pdcp-config | PDCP-Configuration, |
| qoS-Flow-QoS-Parameter-List | QoS-Flow-QoS-Parameter-List, |
| qoSFlowLevelQoSParameters | QoSFlowLevelQoSParameters OPTIONAL, |

```
  iE-Extensions ProtocolExtensionContainer { {MCMRBSetupConfiguration-
Item-ExtIEs} } OPTIONAL,
  ...
}
```

In the example 2, the CU-CP 172A omits the SDAP-Configuration from the MCMRBSetupConfiguration-Item.

In some implementations, the CU-CP 172A generates the second MBS QoS flow configuration(s) based on the first MBS QoS flow configuration(s). For example, the second MBS QoS flow configuration(s) are the same as the first MBS QoS flow configuration(s). In another example, the second MBS QoS flow configuration(s) are similar to the first MBS QoS flow configuration(s).

In cases where the CU-CP 172A receives the first slice information from the CN 110, e.g., in the first CN-to-BS message, the CU-CP 172A can include the first slice information in the first CP-to-UP message to indicate that the particular network slice indicated by the first slice information is used for the first MBS session. In cases where the CU-CP 172A does not receive slice information from the CN 110, e.g., in the first CN-to-BS message, the CU-CP 172A can include preconfigured slice information in the first CP-to-UP message to indicate a particular network slice is used for the first MBS session. Alternatively, the CU-CP 172A in such cases omits slice information from the first CP-to-UP message to indicate a default network slice is used for the first MBS session.

In cases where the CU-CP 172A receives the first MBS area information from the CN 110, e.g., in the first CN-to-BS message, the CU-CP 172A can include the first MBS area information in the first CP-to-UP message. In cases where the CU-CP 172A does not receive MBS area information from the CN 110, e.g., in the first CN-to-BS message, the CU-CP 172A can include preconfigured MBS area information in the first CP-to-UP message. Alternatively, the CU-CP 172A in such cases omits MBS area information from the first CP-to-UP message. In cases where the CU-CP 172A receives the first MBS area information from the CN 110, e.g., in the first CN-to-BS message, the CU-CP 172A can retrieve an MBS Area Session ID from the first MBS area information and include the MBS Area Session ID in the first CP-to-UP message. In such cases, the CU-CP 172A may refrain from including an MBS Service Area Information IE in the first CP-to-UP message. In cases where the CU-CP 172A does not receive MBS area information from the CN 110, e.g., in the first CN-to-BS message, the CU-CP 172A can include preconfigured MBS Area Session ID in the first CP-to-UP message. Alternatively, the CU-CP 172A in such cases omits MBS Area Session ID from the first CP-to-UP message.

In response to the first CP-to-UP message, the CU-UP 172B establishes or configures resources for the MRB(s) and sends 562 a first UP-to-CP message (e.g., MC Bearer Context Setup Response message). In some implementations, the CU-UP 172B configures resources for each of the MRB(s) based on the corresponding MRB configuration parameters and/or particular one(s) of the second MBS QoS flow configuration(s). In some implementations, the CU-UP 172B configures resources for the MRB(s), MBS QoS flow(s) and/or first MBS session based on the first slice information. In some implementations, the CU-UP 172B establishes and/or configures PDCP entity/entities 1, . . . , N in accordance with the PDCP configuration(s) 1, . . . , N for the MRB(s) or MRB ID(s) 1, . . . , N, respectively. In other implementations, for each of PDCP configuration(s) 1, . . . , N, the CU-UP 172B ignores or discards a portion of the PDCP configuration and establishes and/or configures a PDCP entity in accordance with the rest of the PDCP configuration. In one implementation, the CU-UP 172B ignores or discards the UL PDCP sequence number size configuration and establishes and/or configures a PDCP entity in accordance with the DL PDCP sequence number size configuration and/or RLC mode. In another implementation, the CU-UP 172B ignores or discards the UL PDCP sequence number size configuration and the RLC mode and establishes and/or configures a PDCP entity in accordance with the DL PDCP sequence number size configuration.

In some implementations, the CU-UP 172B establishes and/or configures SDAP entity/entities 1, . . . , N in accordance with the SDAP configuration(s) 1, . . . , N for the MRB(s) or MRB ID(s) 1, . . . , N, respectively. In other implementations, for each of SDAP configuration(s) 1, . . . , N, the CU-UP 172B ignores or discards a portion of the SDAP configuration and establishes and/or configures a SDAP entity in accordance with the rest of the SDAP configuration. In one implementation, the CU-UP 172B ignores or discards the default DRB configuration and SDAP UL header configuration and establishes and/or configures a SDAP entity in accordance with the SDAP DL header configuration. In another implementation, the CU-UP 172B ignores or discards the default DRB configuration and establishes and/or configures a SDAP entity in accordance with the SDAP UL header configuration and SDAP DL header configuration. In yet other implementations, the CU-UP 172B ignores or discards the entire SDAP configuration, because the CU-UP 172B determines not to use SDAP to transmit MBS data of the first MBS session.

In some implementations, the CU-UP 172B includes, in the first UP-to-CP message, a first CU transport layer configuration to configure a common CN-to-BS DL tunnel for the first MBS session configuration. In some implementations, the first CU transport layer configuration includes a CU transport layer address (e.g., an IP address and/or a TEID) to identify a first common CN-to-BS DL tunnel (e.g., a unicast NG-U transport the GTP DL TEID, or a shared resource address (GTP DL TEID). In other implementations, the first CU transport layer configuration is a MC Bearer Context NG-U TNL Info at NG-RAN IE. In some implementations, the CU-CP 172A includes a first CU-CP MBS E1AP ID in the first CP-to-UP message to identify the first MBS session on an E1 interface between the CU-CP 172A and CU-UP 172B. In some implementations, the CU-UP 172B includes a first CU-UP MBS E1AP ID in the first UP-to-CP message to identify the first MBS session on an E1 interface between the CU-CP 172A and CU-UP 172B. The CU-UP 172B can include the first CU-CP MBS E1AP ID in the first UP-to-CP message.

The events 560 and 562 are collectively referred to in FIG. 5A as an MC Bearer Context Setup procedure.

After (e.g., in response to) receiving 504 the first CN-to-BS message or 562 the first UP-to-CP message, the CU-CP 172A sends 512 a second BS-to-CN message (e.g., a Distribution Setup Request message) to the CN 110. The CN 110 in response sends 514 a second CN-to-BS message (e.g., a Distribution Setup Response message) to the CU-CP 172A. For unicast transport, DL/UL GTP TEIDs are exchanged in the second BS-to-CN and CN-to-BS messages; for multicast transport, multicast address information is fetched from the CN 110 in the second CN-to-BS message. In some implementations, multicast session QoS parameters are provided by CN 110 to the CU-CP 172A in the second CN-to-BS message instead of the first CN-to-BS message.

After (e.g., in response to) receiving 514 the second CN-to-BS meesgae, the CU-CP 172A sends 564 a second CP-to-UP message (e.g., MC Bearer Context Modification Request message) to the CU-UP 172B to provide the 5GC UL TEID and the multicast session QoS parameters which the CU-CP 172A received in the second CN-to-BS message. The CU-UP 172B in response sends 566 a second UP-to-CP message (e.g., MC Bearer Context Modification Response message) to the CU-CP 172A.

After (e.g., in response to) receiving 504 the first CN-to-BS message or 566 the second UP-to-CP message, the CU-CP 172A sends 506 a first CU-to-DU message (e.g., a Multicast Context Setup Request message) to the DU 174 to request a set-up for an multicast context and/or a common DL tunnel for the first MBS session. The CU-CP 172A determines to configure one or more MRBs for the first MBS session or the MBS QoS flow(s) 1, . . . , M. In response to the determination, the CU-CP 172A generates a MRB to be setup configuration for requesting resources for the one or more MRBs. In some implementations, the first CU-to-DU message includes the first MBS session ID, the MRB to be setup configuration, and/or third MBS QoS flow configuration(s) for the first MBS session. In some implementations, the CU-CP 172A includes the first slice information in the first CU-to-DU message to indicate that the particular network slice indicated by the first slice information is used for the first MBS session. In some implementations, the MRB to be setup configuration include MRB ID(s) each identifying a MRB and the DU 174 configures resources (e.g., PHY, MAC and/or RLC resources) for the MRB(s). The MRB ID(s) included in the first CU-to-DU message is/are the same as the MRB ID(s) included in the first CP-to-UP message. For example, the MRB to be setup configuration includes the MRB ID(s) 1, . . . , N for the MRB(s) 1, . . . , N, respectively. The third MBS QoS flow configuration(s) include QoS parameters required for the MBS QoS flow(s) associated with the first MBS session. In some implementations, the third MBS QoS flow configuration(s) include MBS QoS flow identifier(s) 1, . . . , M and/or MBS QoS flow level QoS parameter(s) 1, . . . , M for the MBS QoS flow(s) 1, . . . , M associated with the first MBS session, respectively. The MBS QoS flow identifier(s) 1, . . . , M identify the MBS QoS flow(s) 1, . . . , M, respectively. In the MRB to be setup configuration, the CU-CP 172A can configure mapping(s) or association(s) between the MBS QoS flow(s) and MRB(s). For example, the MRB to be setup configuration includes MRB to be setup configuration item(s) 1, . . . , N for the MRB(s) 1, . . . , N, respectively. In some implementations, the MRB to be setup configuration item Y includes MRB ID Y and particular MBS QoS flow configuration(s) of the third MBS QoS flow configuration(s), for MRB Y of the MRB(s) 1, . . . , N, where 1≤Y≤N. In some implementations, the CU-CP 172A generates the third MBS QoS flow configuration(s) based on the first MBS QoS flow configuration(s). For example, the third MBS QoS flow configuration(s) are the same as the first MBS QoS flow configuration(s). In another example, the third MBS QoS flow configuration(s) are similar to the first MBS QoS flow configuration(s). In some implementations, the CU-CP 172A includes a CU MBS F1AP ID in the first CU-to-DU message to identify the first MBS session on an F1 interface between the CU-CP 172A and DU 174.

In cases where the CU-CP 172A receives the first slice information (e.g., S-NSSAI) associated with the first MBS session from the CN 110, e.g., in the first CN-to-BS message, the CU-CP 172A includes the first slice information in the first CU-to-DU message to indicate the particular network slice is used for the first MBS session. In cases where the CU-CP 172A does not receive slice information (e.g., S-NSSAI) associated with the first MBS session from the CN 110, e.g., in the first CN-to-BS message, the CU-CP 172A includes preconfigured slice information in the first CU-to-DU message. Alternatively, the CU-CP 172A in such cases omit slice information in the first CP-to-UP message.

In cases where the CU-CP 172A receives the first MBS area information from the CN 110, e.g., in the first CN-to-BS message, the CU-CP 172A can include the first MBS area information in the first CU-to-DU message. In cases where the CU-CP 172A does not receive MBS area information from the CN 110, e.g., in the first CN-to-BS message, the CU-CP 172A can include preconfigured MBS area information in the first CU-to-DU message. Alternatively, the CU-CP 172A in such cases omits MBS area information from the first CU-to-DU message. In cases where the CU-CP 172A receives the first MBS area information from the CN 110, e.g., in the first CN-to-BS message, the CU-CP 172A can retrieve an MBS Area Session ID from the first MBS area information and include the MBS Area Session ID in the first CU-to-DU message. In cases where the CU-CP 172A does not receive MBS area information from the CN 110, e.g., in the first CN-to-BS message, the CU-CP 172A can include preconfigured MBS Area Session ID in the first CU-to-DU message. Alternatively, the CU-CP 172A in such cases omits MBS Area Session ID from the first CU-to-DU message.

In response to receiving 506 the first CU-to-DU message, the DU 174 establishes or configure resources (e.g., a multicast context and/or PHY, MAC, RLC and/or tunnel resources) for the MRB(s) and sends 508 a first DU-to-CU message (e.g., a Multicast Context Setup Response message) to the CU-CP 172A. In some implementations, the DU 174 establishes and/or configure a MAC entity for the MRB(s). In some implementations, the DU 174 establishes and/or configures RLC entity/entities 1, . . . , N for the MRB(s) or MRB ID(s) 1, . . . , N, respectively. In some implementations, the DU 174 includes, in the first DU-to-CU message, a first DU transport layer configuration to configure a common CU-to-DU DL tunnel for the first MBS session (e.g., for an MRB identified by one of the MRB ID(s)). The DU 174 can include, in the first DU-to-CU message, additional DU transport layer configuration(s) to configure additional common CU-to-DU DL tunnel(s) for additional MRB(s) identified by additional MRB ID(s) of the MRB IDs. In some implementations, the DU 174 can include, in the first DU-to-CU message, the MRB ID(s) associated with the first DU transport layer configuration and/or the additional DU transport layer configuration(s). For example, each of the MRB ID(s) is associated with a particular DU transport layer configuration. In some implementations, each of the first DU transport layer configuration and/or the additional DU transport layer configuration(s) includes a DU transport layer address (e.g., an IP address and/or a TEID). In some implementations, each of the first DU transport layer configuration and/or the additional DU transport layer configuration(s) can be a MRB F1-U TNL Info at DU IE.

The events 506 and 508 are collectively referred to in FIG. 5A as a Multicast Context Setup procedure.

In some implementations, the DU 174 transmits 510 a second DU-to-CU message (e.g., Multicast Distribution Setup Request message) to the CU-CP 172A after receiving 506 the first CU-to-DU message or transmitting 508 the first DU-to-CU message. In some implementations, the DU 174 includes the first DU transport layer configuration and/or the additional DL transport layer configuration(s) in the second DU-to-CU message instead of the first DU-to-CU message. In some implementations, the DU 174 can include, in the second DU-to-CU message, the MRB ID(s) associated with the first DU transport layer configuration and/or the additional DU transport layer configuration(s) instead of the first DU-to-CU message. Thus, the first DU-to-CU message does not include a DU transport layer configuration. In some implementations, the CU-CP 172A transmits 516 a second CU-to-DU message (e.g., Multicast Distribution Setup Response message) to the DU 174 in response to the second DU-to-CU message. In some implementations, the CU-CP 172A transmits 516 the second CU-to-DU message in response or after the events 567 and 568 as described later. The events 510 and 516 are collectively referred to in FIG. 5A as a Multicast Distribution Setup procedure between CU-CP 172A and the DU 174.

After receiving 510 the second DU-to-CU message, the CU-CP 172A sends 567 a third CP-to-UP message (e.g., MC Bearer Context Modification Request message) to the CU-UP 172B. In some implementations, the CU-CP 172A includes the MRB ID(s), first DU transport layer configuration, additional DU transport layer configuration(s) and/or first CN transport layer configuration in the third CP-to-UP message. In response to the third CP-to-UP message of event 567, the CU-UP 172B sends 568 a third UP-to-CP message (e.g., MC Bearer Context Modification Response message). In some implementations, the CU-UP 172B includes the MRB ID(s) and/or a second CU transport layer configuration in the second UP-to-CP message. In some implementations, the second CU transport layer configuration includes a CU transport layer address (e.g., an IP address) to identify a first common DU-to-CU UL tunnel. The second CU transport layer configuration can additionally include a TEID at/of the CU-UP 172B. In some implementations, the CU-CP 172A includes the second CU transport layer configuration in the second CU-to-DU message and sends 516 the second CU-to-DU message to the DU 174 in response to the second DU-to-CU message of event 510. After receiving 568 the third UP-to-CP message or transmitting 516 the second CU-to-DU message, the CU-CP 172A sends 518 a second BS-to-CN message (e.g. Multicast Session Activation Response message or PDU Session Resource Modify Request message) to the CN 110 in response to the first CN-to-BS message. Alternatively, the CU-CP 172A sends 518 the second BS-to-CN message to the CN 110 before receiving 568 the third UP-to-CP message or transmitting 516 the second CU-to-DU message. For example, the CU-CP 172A sends 518 the second BS-to-CN message to the CN 110 after receiving 504 the first CN-to-BS message, receiving 562 the first UP-to-CP message, receiving 510 the second DU-to-CU message or receiving 514 the second CN-to-BS message.

In some implementations, the CU-CP 172A can include the fourth MBS QoS flow configuration(s) in the MC Bearer Context Modification Request message. In such implementations, the CU-UP 172B can modify or reconfigure resources for the MRB(s) based on the fourth MBS QoS flow configuration(s). In some implementations, the CU-UP 172B can determine whether to modify or reconfigure resources for the MRB(s) based on the fourth MBS QoS flow configuration(s). For example, if the resources for the MRB(s) at event 564 still can fulfill the fourth MBS QoS flow configuration(s), the CU-UP 172B does not modify or reconfigure resources for the first MRB. Otherwise, the CU-UP 172B modifies or reconfigures resources for the MRB(s) based on the fourth MBS QoS flow configuration(s). In some implementations, the CU-UP 172B can determine whether to modify or reconfigure resources for a particular MRB of the MRB(s) based on the fourth MBS QoS flow configuration(s). For example, if the resources for a first MRB of the MRB(s) at event 564 still can fulfill particular one(s) of the fourth MBS QoS flow configuration(s) for particular MBS QoS flow(s) mapped to the first MRB, the CU-UP 172B does not modify or reconfigure resources for the first MRB. Otherwise, the CU-UP 172B modifies or reconfigures resources for the first MRB based on the particular MBS QoS flow configuration(s).

The events 504, 560, 562, 506, 508, 510, 512, 514, 564, 566, 516, 567, 568, and 518 are collectively referred to in FIG. 5A as an MBS session resource setup procedure 592A.

After or during the MBS session resource setup procedure 592A, the CU-CP 172A can send 522 to the DU 174 a UE Context Request message for the UE 102. In some implementations, the CU-CP 172A can include the MRB ID(s) in the UE Context Request message. In some implementations, the CU-CP 172A determines the MRB ID(s) based on the first MBS session ID and/or MBS QoS flow identifier(s) received in the second CN-to-BS message. In some implementations, the CU-CP 172A may not include the first MBS session ID in the UE Context Request message.

In response to the UE Context Request message of event 522, the DU 174 sends 524 to the CU-CP 172A a UE Context Response message including multicast configuration parameters for the UE 102A to receive MBS data of the first MBS session via the MRB(s) for connected state. In some implementations, some or all of the multicast configuration parameters may be associated to the MRB(s)/MRB ID(s). In some implementations, the DU 174 generates a DU configuration (i.e., a first DU configuration) to include the multicast configuration parameters (i.e., first multicast configuration parameters) and includes the DU configuration in the UE Context Response message. In some implementations, the DU configuration can be a CellGroupConfig IE. In other implementations, the DU configuration can be an MBS-specific IE. In some implementations, the multicast configuration parameters configure one or more logical channels (LCs) for the MRB(s). For example, the multicast configuration parameters include one or more logical channel IDs (LCIDs) to configure the one or more logical channel. Each of the LCIDs identifies a particular logical channel of the one or more logical channels.

In some implementations, the UE Context Request message and the UE Context Response message are a UE Context Setup Request message and a UE Context Setup Response message, respectively. In other implementations, the UE Context Request message and the UE Context Response message are a UE Context Modification Request message and a UE Context Modification Response message, respectively.

In some implementations, the CU-CP 172A can perform a (UE-specific) Bearer Context procedure with the CU-UP 172B after (e.g., in response to) receiving the second CN-to-BS message. In the Bearer Context procedure, the CU-CP 172A sends a Bearer Context Request message to the CU-UP 172B to request establishing or modifying a (unicast) bearer context for the UE 102. In response, the CU-UP 172B establishes or modifies a (unicast) bearer context for the UE 102 and sends a Bearer Context Response message to the CU-CP 172A. In other implementations, the CU-CP 172A refrains from performing a (UE-specific) Bearer Context procedure for the UE 102 with the CU-UP 172B upon receiving the second CN-to-BS message. In some implementations, the Bearer Context procedure is a Bearer Context Setup procedure defined in section 8.3.1 in 3GPP specification 37.483 or 38.463. In such cases, the Bearer Context Request message and Bearer Context Setup message are Bearer Context Setup Request message and Bearer Context Setup Response message, respectively. In other implementations, the Bearer Context procedure is a Bearer Context Modification procedure defined in section 8.3.2 in 3GPP specification 37.483 or 38.463. In such cases, the Bearer Context Request message and Bearer Context Setup message are Bearer Context Modification Request message and Bearer Context Modification Response message, respectively.

After receiving 524 the UE Context Response message, the CU-CP 172A generates an RRC reconfiguration message (e.g., RRCReconfiguration message) including the multicast configuration parameters and one or more MRB configurations (i.e., first MRB configuration(s)) for connected state and transmits 526 the RRC reconfiguration message to the DU 174. The first MRB configuration(s) configures the MRB(s) (e.g., the MRB(s) 1, . . . , N). In some implementations, the first MRB configuration(s) include the MRB ID(s) and PDCP configuration(s). In turn, the DU 174 transmits 528 the RRC reconfiguration message to the UE 102 operating in the connected state. The UE 102 in the connected state then transmits 530 an RRC reconfiguration complete message to the DU 174, which in turn transmits 531 the RRC reconfiguration complete message (e.g., RRCReconfigurationComplete message) to the CU-CP 172A.

In some implementations, the UE 102 configures or establishes PDCP entity/entities (e.g., NR PDCP 210) for the MRB(s) and configures a MAC entity (e.g., MAC 204B) in accordance with the multicast configuration parameters.

The events 520, 522, 524, 526, 528, 530, and 531 are collectively referred to in FIG. 5A as a UE-specific MBS session configuration procedure 594. The CN 110 and/or CU-CP 172A perform the procedure 594 for each of UEs (e.g., the UE 102A and the UE 102B) joining the first MBS session. In some scenarios or implementations, the procedure 594 can occur before the procedure 592A. In other scenarios or implementations, the procedure 594 can occur after the procedure 592A. In yet other scenarios or implementations, the procedure 594 can overlap with the procedure 592A.

In some implementations, the CU-CP 172A generates a PDCP PDU including the RRC reconfiguration message and sends 526 a CU-to-DU message including the PDCP PDU to the DU 174. In such implementations, the DU 174 retrieves the PDCP PDU from the CU-to-DU message and transmits 528 the PDCP PDU to the UE 102 via the RLC layer 206B, MAC layer 204B and PHY layer 202B. The UE 102 receives 528 the PDCP PDU from the DU 174 via the PHY layer 202B, MAC layer 204B, and RLC layer 206B. In some implementations, the UE 102 generates a PDCP PDU including the RRC reconfiguration complete message and transmits 530 the PDCP PDU to the DU 174 via the RLC layer 206B, MAC layer 204B, and PHY layer 202B. The DU 174 receives 530 the PDCP PDU from the UE 102 via the PHY layer 202B, MAC layer 204B, and RLC layer 206B, and sends 531 a DU-to-CU including the PDCP PDU to the CU-CP 172A. The CU-CP 172A retrieves the PDCP PDU from the DU-to-CU message and retrieves the RRC reconfiguration complete message from the PDCP PDU.

After receiving 518 the second BS-to-CN message, the CN 110 (e.g., (MB-)UPF 162) sends 590 MBS data (e.g., one or multiple MBS data packets) for the first MBS session to the CU-UP 172B via the first common CN-to-BS DL tunnel (i.e., in accordance with the first CU transport layer configuration and/or the first CN transport layer configuration). In some implementations, the CN 110 generates tunnel packets each including a particular MBS data packet to transmit the MBS data packets via the first common CN-to-BS DL tunnel. In a header of each of the tunnel packets, the CN 110 sets a source IP address, a target IP address and a TEID to the IP address in the first CN transport layer configuration, the IP address in the first CU transport layer configuration, and the TEID in the first CU transport layer configuration, respectively. In such implementations, the IP address in the first CN transport layer configuration, the IP address in the first CU transport layer configuration, and the TEID in the first CU transport layer configuration identify the first common CN-to-BS DL tunnel.

When the CU-UP 172B receives 532 the MBS data of the first MBS session from the CN 110, the CU-UP 172B in turn sends 534 the MBS data to the DU 174 via the first common CU-to-DU tunnel and/or additional common CU-to-DU DL tunnel (i.e., in accordance with the first and/or additional DU transport layer configuration(s)). In cases where the MBS data is associated with one or some of the MBS QoS flow(s) identified by the MBS QoS flow identifier(s), the CU-UP 172B can determine to use which common CU-to-DU DL tunnel(s) to send the MBS data to the DU 174, based on the one or some of MBS QoS flow identifier(s). For example, when the CU-UP 172B receives from the CN 110 a first MBS data packet associated with a first one of the MBS QoS flow identifier(s), the CU-UP 172B sends the first MBS data packet to the DU 174 via the first common CU-to-DU DL tunnel. When the CU-UP 172B receives from the CN 110 a second MBS data packet associated with a second one of the MBS QoS flow identifier(s), the CU-UP 172B sends the second MBS data packet to the DU 174 via a one of the additional common CU-to-DU tunnel(s). In some implementations, the CU-UP 172B generates tunnel packets each including a particular MBS data packet to transmit the MBS data packets via the first common CU-to-DU tunnel and/or additional common CU-to-DU DL tunnel. In cases where the CU-UP 172B transmits one of the tunnel packets via the first common CU-to-DU tunnel, the CU-UP 172B sets a source IP address, a target IP address and a TEID in header of the tunnel packet to the IP address in the second CU transport layer configuration, the IP address in the first DU transport layer configuration, and the TEID in the first DU transport layer configuration, respectively. In such implementations, the IP address in the second CU transport layer configuration, the IP address in the first DU transport layer configuration, and the TEID in the first DU transport layer configuration identify the first common CU-to-DU DL tunnel. In cases where the CU-UP 172B transmits one of the tunnel packets via the additional common CU-to-DU tunnel, the CU-UP 172B sets a source IP address, a target IP address and a TEID in a header of the tunnel packet to the IP address in the second CU transport layer configuration, the IP address in the additional DU transport layer configuration, and the TEID in the additional DU transport layer configuration, respectively. In such implementations, the IP address in the second CU transport layer configuration, the IP address in the additional DU transport layer configuration, and the TEID in the additional DU transport layer configuration identify the first common CU-to-DU DL tunnel.

When the DU 174 receives 534 the MBS data from the CU-UP 172B, the DU 174 transmits (e.g., multicast or unicast) 536 the MBS data via the one or more logical channels to the UE 102. The UE 102 receives 536 the MBS data via the one or more logical channels. For example, the CU-UP 172B may receive 532 an MBS data packet, generate a PDCP PDU including the MBS data packet, and transmit 534 the PDCP PDU to the DU 174. In turn, the DU 174 generates a MAC PDU including the logical channel ID and the PDCP PDU, and transmits 536 the MAC PDU to the UE 102 via multicast or unicast. The UE 102 receives 536 the MAC PDU via multicast or unicast, retrieves the PDCP PDU and the logical channel ID from the MAC PDU, identifies the PDCP PDU associated with the MRB in accordance with the logical channel ID, and retrieves the MBS data packet from the PDCP PDU in accordance with a PDCP configuration within the MRB configuration. In some implementations, the DU 174 can transmit 536 the MBS data or the MAC PDU via one or more multicast transmissions (e.g., dynamic or SPS multicast transmission(s)) to the UE 102 as described above. In such cases, the UE 102 can receive 536 the MBS data or the MAC PDU via the one or more multicast transmissions from the DU 174 as described above. In some implementations, the UE 102 uses the MAC entity to receive 536 the MAC PDU or MBS data and uses the PDCP entity/entities to process the PDCP PDU to obtain the MBS data.

In some implementations, the CU-CP 172A can request the DU 174 to configure a UE-specific CU-to-DU DL tunnel for the UE 102 in the UE Context Request message of event 522. In some implementation, the CU-CP 172A can include a CU transport layer configuration in the UE Context Request message to request a UE-specific CU-to-DU DL tunnel for the UE 102. The CU transport layer configuration includes a CU transport layer address (e.g., an IP address) to identify a UE-specific CU-to-DU DL tunnel. The CU transport layer configuration can additionally include a TEID at/of the CU-UP 172B. In response, the DU 174 can include, in the UE Context Response message, a DU transport layer configuration configuring the UE-specific CU-to-DU DL tunnel. The DU transport layer configuration includes a DU transport layer address (e.g., an IP address and/or a TEID). After receiving 524 the UE Context Response message, the CU-CP 172A can send a Bearer Context Modification Request message including the DU transport layer configuration to the CU-UP 172B and in response, the CU-UP 172B sends a Bearer Context Modification Response message to the CU-CP 172A. After that, the CU-UP 172B can transmit 534 the MBS data to the DU 174 via the UE-specific CU-to-DU DL tunnel.

In some implementations, the multicast configuration parameters can also include one or more RLC bearer configurations, each associated with a particular MRB. Each of the MRB configuration(s) can include an MRB ID, a PDCP configuration, the first MBS session ID, a PDCP reestablishment indication (e.g., reestablishPDCP), and/or a PDCP recovery indication (e.g., recoveryPDCP). In some implementations, the PDCP configuration can be a PDCP-Config IE for DRB. In some implementations, the RLC bearer configuration can be an RLC-BearerConfig IE. In some implementations, the RLC bearer configuration may include a logical channel (LC) ID configuring a logical channel. In some implementations, the logical channel can be a (multicast) MBS traffic channel (MTCH). In other implementations, the logical channel can be a dedicated traffic channel (DTCH). In some implementations, the multicast configuration parameters may include a logical channel configuration (e.g., LogicalChannelConfig IE) configuring the logical channel. In some implementations, the RLC bearer configuration may include the MRB ID.

In some implementations, the CU-CP 172A can configure the MRB as a DL-only RB in the MRB configuration. For example, the CU-CP 172A can refrain from including UL configuration parameters in the PDCP configuration within the MRB configuration to configure the MRB as a DL-only RB. The CU-CP 172A can include only DL configuration parameters in the MRB configuration, e.g., as described above. In such cases, the CU-CP 172A configures the UE 102 to not transmit UL PDCP data PDU via the MRB to the DU 174 and/or the CU-CP 172A by excluding the UL configuration parameters for the MRB in the PDCP configuration in the MRB configuration. In another example, the DU 174 refrains from including UL configuration parameters in the RLC bearer configuration. In such cases, the DU 174 configures the UE 102 not to transmit the control PDU(s) via the logical channel to the base station 104 by excluding the UL configuration parameters from the RLC bearer configuration.

In cases where the DU 174 includes UL configuration parameter(s) in the RLC bearer configuration, the UE 102 may transmit control PDU(s) (e.g., PDCP Control PDU(s) and/or RLC Control PDU(s)) via the logical channel to the DU 174 using the UL configuration parameter(s). If the control PDU is a PDCP control PDU, the DU 174 can send the PDCP control PDU to the CU-UP 172B. For example, the CU-CP 172A may configure the UE to receive MBS data with a (de) compression protocol (e.g., robust header compression (ROHC) protocol). In this case, when the CU-UP 172B receives 532 an MBS data packet from the CN 110, the CU-UP 172B compresses the MBS data packet with the compression protocol to obtain compressed MBS data packet(s) and transmits 534 a PDCP PDU including the compressed MBS data packet to the DU 174 via the first or additional common CU-to-DU DL tunnel. In turn, the DU 174 transmits (e.g., multicast or unicast) 536 the PDCP PDU to the UE 102 via the logical channel. When the UE 102 receives the PDCP PDU via the logical channel, the UE 102 retrieves the compressed MBS data packet from the PDCP PDU. The UE 102 decompresses the compressed MBS data packet(s) with the (de) compression protocol to obtain the original MBS data packet. In such cases, the UE 102 may transmit a PDCP Control PDU including, a header compression protocol feedback (e.g., interspersed ROHC feedback) for operation of the header (de) compression protocol, via the logical channel to the DU 174. In turn, the DU 174 sends the PDCP Control PDU to the CU-UP 172B via a UL tunnel. In some implementations, the UL tunnel is a first common DU-to-CU tunnel configured in the first DU transport layer configuration and the second CU transport layer configuration. For example, the IP address in the first DU transport layer configuration, and the IP address and TEID in the second CU transport layer configuration identify the first common DU-to-CU tunnel. In other implementations, the UL tunnel is specific for the UE 102 (e.g., the UE 102A). In some implementations, the CU-CP 172A can include, in the UE Context Request message, a CU transport layer configuration configuring the UE-specific UL tunnel. The CU transport layer configuration includes a CU transport layer address (e.g., an Internet Protocol (IP) address) and a TEID to identify the UE-specific UL tunnel. The DU 174 can include, in the UE Context Response message, a DU transport layer configuration configuring the UE-specific UL tunnel. The DU transport layer configuration includes a DU transport layer address (e.g., an IP address and/or a TEID). For example, the IP address in the DU transport layer configuration, and the IP address and TEID in the CU transport layer configuration identify the first common UL tunnel.

In some implementations, the MRB configuration can be an MRB-ToAddMod IE including an MRB ID (e.g., mrb-Identity or MRB-Identity). An MRB ID identifies a particular MRB of the MRB(s). In cases where the CU-CP 172A has configured DRB(s) to the UE 102 for unicast data communication, the CU-CP 172A in some implementations can set one or more of the MRB ID(s) to values different from DRB ID(s) of the DRB(s). In such cases, the UE 102 and the CU-CP 172A can distinguish whether an RB is an MRB or DRB in accordance an RB ID of the RB. In other implementations, the CU-CP 172A can set one or more of the MRB ID(s) to values which can be the same as the DRB ID(s). In such cases, the UE 102 and the CU-CP 172A can distinguish whether an RB is an MRB or DRB in accordance an RB ID of the RB and an RRC IE configuring the RB. For example, a DRB configuration configuring a DRB is a DRB-ToAddMod IE including a DRB identity (e.g., drb-Identity or DRB-Identity) and a PDCP configuration. Thus, the UE 102 can determine an RB is a DRB if the UE 102 receives a DRB-ToAddMod IE configuring the RB, and determine an RB is an MRB if the UE 102 receives an MRB-ToAddMod IE configuring the RB. Similarly, the CU-CP 172A can determine an RB is a DRB if the CU-CP 172A transmits a DRB-ToAddMod IE configuring the RB to the UE 102, and determine an RB is an MRB if the CU-CP 172A transmits an MRB-ToAddMod IE configuring the RB to the UE 102.

In some implementations, the multicast configuration parameters for receiving MBS data of the first MBS session include one or more logical channel (LC) IDs to configure one or more logical channels. In some implementations, the logical channel(s) can be dedicated traffic channel(s) (DTCH(s)). In other implementations, the logical channel(s) can be multicast traffic channel(s) (MTCH(s)).

In some implementations, the multicast configuration parameters can include dynamic scheduling multicast configuration parameter(s) for the UE 102 to receive multicast transmissions each including MBS data or a particular portion of MBS data. In some implementations, the dynamic scheduling multicast configuration parameter(s) can include at least one of the following configuration parameters:
Group radio network temporary identifier (G-RNTI). The DU 174 dynamically schedules each multicast transmission, including a particular MAC PDU, for the UE 102 by generating a DCI, scrambling a cyclic redundancy check (CRC) of the DCI with the G-RNTI, and transmitting the DCI and the scrambled CRC on a PDCCH. The MAC PDU can include an MBS data packet or a portion of an MBS data packet. The UE 102 receives the DCI and scrambled CRC on the PDCCH and verifies the scrambled CRC with the G-RNTI. For each multicast transmission, after the UE 102 verifies the (scrambled) CRC is valid, the UE 102 receives the multicast transmission in accordance with the corresponding DCI and retrieves the particular MAC PDU from the multicast transmission. In this case, each multicast transmission is a dynamic scheduling multicast transmission used in the following description. In some implementations, each DCI includes configuration parameters configuring a dynamic scheduling multicast radio resource scheduling the corresponding multicast transmission. In some implementations, the configuration parameters can include at least one of the following parameters. The configuration parameters of the each DCI can include the same values and/or different values for the following configuration parameters.
   Frequency domain resource assignment
   Time domain resource assignment
   Virtual resource block (VRB)-to-physical resource block (PRB) mapping
   Modulation and coding scheme (MCS)
   New data indicator
   Redundancy version
   HARQ process number
   Downlink assignment index
   PUCCH resource indicator
HARQ codebook (ID), which indicates a HARQ acknowledgement (ACK) codebook index for a corresponding HARQ ACK codebook for a dynamic scheduling multicast transmission received by the UE 102. The DU 174 uses the HARQ codebook (ID) to receive a HARQ ACK. In cases where the configuration parameters do not include the HARQ codebook (ID), the UE 102 and DU 174 may use a HARQ codebook (ID) for unicast transmission. In some implementations, the UE 102 can receive the HARQ codebook (ID) for unicast transmission in the DU configuration from the DU 174. In other implementations, the UE 102 can receive the HARQ codebook (ID) for unicast transmission in another DU configuration from the DU 174.
PUCCH resource configuration, which indicates a HARQ resource on a PUCCH where the UE 102 transmits a HARQ feedback (e.g., HARQ ACK and/or negative ACK (NACK)) for a dynamic scheduling multicast transmission. In cases where the configuration parameters do not include the PUCCH resource configuration, the UE 102 and DU 174 can use a PUCCH resource configuration for unicast transmissions to communicate HARQ feedback.
HARQ NACK only indication, which configures the UE 102 to only transmit a HARQ negative ACK (NACK) for a dynamic scheduling multicast transmission that the UE 102 receives from the DU 174 and from which the UE 102 fails to obtain a transport block. In some implementations, the UE 102 fails to obtain the transport block because the UE 102 fails a cyclic redundancy check (CRC) for the transport block or the UE 102 does not receive the dynamic scheduling multicast transmission. In accordance with the indication, the UE 102 refrains from transmitting to the DU 174 a HARQ ACK for a dynamic scheduling multicast transmission that the UE 102 successfully receives and from which the UE 102 obtains a transport block. In cases where the configuration parameters do not include the indication, the UE 102 can transmit to the DU 174 a HARQ ACK for a dynamic scheduling multicast transmission that the UE 102 successfully receives and from which the UE 102 obtains a transport block.
HARQ ACK/NACK indication, which configures the UE 102 to transmit a HARQ NACK for a dynamic scheduling multicast transmission where the UE 102 fails to obtain a transport block and configures the UE 102 to transmit a HARQ ACK for a dynamic scheduling multicast transmission that the UE 102 successfully receives and from which the UE 102 obtains a transport block. In cases where the configuration parameters do not include the indication, the UE 102 refrains from transmitting to the DU 174 a HARQ ACK for a dynamic scheduling multicast transmission that the UE 102 successfully receives and from which the UE 102 obtains a transport block. In such cases, the UE 102 is only allowed to transmit to the DU 174 a HARQ NACK for a dynamic scheduling multicast transmission where the UE 102 fails to obtain a transport block.
HARQ ACK indication, which configures the UE 102 to transmit a HARQ ACK for a dynamic scheduling multicast transmission that the UE 102 successfully receives and from which the UE 102 obtains a transport block. In cases where the configuration parameters do not include the indication, the UE 102 refrains from transmitting to the DU 174 a HARQ ACK for a dynamic scheduling multicast transmission where the UE 102 successfully obtains a transport block. In such cases, the UE 102 is only allowed to transmit to the DU 174 a HARQ NACK for a dynamic scheduling multicast transmission where the UE 102 fails to obtain a transport block. In some implementations, the DU 174 can include either one of the HARQ NACK indication, HARQ ACK/NACK indication and HARQ ACK indication.
Modulation and coding scheme (MCS) configuration, which indicates a MCS table that the DU 174 uses to transmit dynamic scheduling multicast transmissions and the UE 102 uses to receive dynamic scheduling multicast transmissions. For example, the MCS table can be a MCS table defined in 3GPP specification 38.214 (e.g., a low-SE 64QAM table indicated in Table 5.1.3.1-3 of 3GPP TS 38.214 or a new table specific for multicast transmission). In some implementations, if DU 174 does not include the MCS configuration in the DU configuration, the UE 102 and DU 174 can apply a MCS table predefined in 3GPP specification 38.214. For example, the predefined MCS table can be a 256QAM table or a 64QAM table, e.g., indicated in Table 5.1.3.1-2 or non-low-SE 64QAM table indicated in Table 5.1.3.1-1 of the specification 38.214, respectively. In cases where the DU 174 does not include the MCS configuration in the DU configuration, the UE 102 and DU 174 can apply a MCS table for unicast transmission to receive dynamic scheduling multicast transmissions from the DU 174. In some implementations, the DU 174 can include, in the DU configuration, a PDSCH configuration (e.g., PDSCH-Config IE) configuring the MCS table for unicast transmissions. In other implementations, the DU 174 can transmit to the UE 102 another DU configuration including the PDSCH configuration, similar to events 516, 518, and 520.
Aggregation factor, which is the number of repetitions for dynamic scheduling multicast transmission(s). The DU 174 can transmit (i.e., multicast) a number of repetitions of a dynamic scheduling multicast transmission in accordance the aggregation factor, and the UE 102 receives the repetitions based on the aggregation factor. In cases where the DU 174 does not include the aggregation factor in the DU configuration, the UE 102 in some implementations can apply an aggregation factor for unicast transmission(s). In some implementations, the DU 174 can include the aggregation factor for unicast transmission(s) to the UE 102 in the DU configuration. In other implementations, the DU 174 can transmit another DU configuration including the aggregation factor for unicast transmissions to the UE 102, similar to events 516, 518, and 520.

The RRC reconfiguration messages for UEs joining the first MBS session, include the same multicast configuration parameters for receiving MBS data of the first MBS session. In some implementations, the RRC reconfiguration messages for the UEs may include the same or different configuration parameters for receiving non-MBS data.

In some implementations, the multicast configuration parameters can include at least one semi-persistent scheduling (SPS) multicast configuration for the UE 102 to receive MBS data. Each of the at least one SPS multicast configuration can include at least one of the following parameters for SPS multicast transmissions.
Group configured scheduling radio network temporary identifier (G-CS-RNTI), which is used to activate or release an SPS multicast radio resource. The DU 174 can activate an SPS multicast radio resource for the UE 102 by generating an SPS multicast radio resource activation command (i.e., a DCI), scrambling a CRC of the DCI with the G-CS-RNTI, and transmitting the DCI and the scrambled CRC on a PDCCH. After activating the SPS multicast radio resource, the DU 174 periodically transmits a multicast transmission on the SPS multicast radio resource in accordance with the DCI. The UE 102 receives the DCI and scrambled CRC on the PDCCH and verifies the scrambled CRC with the G-CS-RNTI. After the UE 102 verifies the (scrambled) CRC is valid, the UE 102 activates (receiving on) the SPS multicast radio resource in response to the DCI and periodically receives a multicast transmission on the SPS multicast radio resource in accordance with the SPS multicast radio resource activation command (i.e., DCI) before the UE 102 deactivates the SPS multicast radio resource. In this case, the multicast transmission is an SPS multicast transmission used in the following description. In some implementations, the DU 174 can deactivate (or release) the SPS multicast radio resource by generating an SPS multicast radio resource deactivation command (i.e., a DCI), scrambling a CRC of the DCI with the G-CS-RNTI, and transmitting the DCI and the scrambled CRC on a PDCCH. The UE 102 receives the DCI and scrambled CRC on the PDCCH and verifies the scrambled CRC with the G-CS-RNTI. After the UE 102 verifies the (scrambled) CRC is valid, the UE 102 deactivates the SPS multicast radio resource, i.e., stops receiving on the SPS multicast radio resource. Each of the SPS multicast transmissions includes a particular MAC PDU which can include an MBS data packet or a portion of an MBS data packet. In some implementations, the SPS multicast radio resource activation command (i.e., DCI) includes configuration parameters configuring the SPS multicast radio resource. In some implementations, the configuration parameters can include at least one of the following parameters.
   Frequency domain resource assignment
   Time domain resource assignment
   Virtual resource block (VRB)-to-physical resource block (PRB) mapping
   Modulation and coding scheme (MCS)
   New data indicator
   Redundancy version
   HARQ process number
   Downlink assignment index
   PUCCH resource indicator
Periodicity, which indicates a periodicity of the SPS multicast radio resource.
Number of HARQ processes, which indicates a number of HARQ processes for communicating SPS multicast transmissions. The DU 174 uses at most the number of HARQ processes to transmit SPS multicast transmissions, and the UE 102 uses at most the number of HARQ processes to receive the SPS multicast transmissions.
HARQ codebook ID, which indicates a HARQ ACK codebook index for a corresponding HARQ ACK codebook for an SPS multicast transmission or an SPS multicast radio resource deactivation command received by the UE 102. In cases where the configuration parameters do not include the HARQ codebook (ID), the UE 102 may use a HARQ codebook (ID) for dynamic scheduling multicast transmission as described above. Alternatively, the UE 102 may use a HARQ codebook (ID) for unicast transmission. In some implementations, the UE 102 can receive the HARQ codebook (ID) for unicast transmission in the DU configuration from the DU 174 as described above.
HARQ process ID offset, which indicates an offset used in deriving HARQ process IDs for the DU 174 to transmit SPS multicast transmissions and for the UE 102 to receive SPS multicast transmissions.
PUCCH resource configuration for SPS multicast transmission, which indicates a HARQ resource on a PUCCH where the UE 102 transmits HARQ feedback (e.g., HARQ ACK and/or negative ACK (NACK)) for an SPS multicast transmission. In cases where the configuration parameters do not include the PUCCH resource configuration for SPS multicast transmission, the UE 102 and DU 174 can use a PUCCH resource configuration for dynamic scheduling multicast transmission to communicate a HARQ feedback as described above. Alternatively, the UE 102 can use a PUCCH resource configuration for unicast transmissions. In some implementations, the UE 102 can use the PUCCH resource configuration for unicast transmissions as described above.
HARQ NACK only indication, which configures the UE 102 to only transmit a HARQ negative ACK (NACK) for an SPS multicast transmission that the UE 102 receives from the DU 174 and from which the UE 102 fails to obtain a transport block. In some implementations, the UE 102 fails to obtain the transport block because the UE 102 fails a cyclic redundancy check (CRC) for the transport block or the UE 102 does not receive the dynamic scheduling multicast transmission. In accordance with the indication, the UE 102 refrains from transmitting to the DU 174 a HARQ ACK for an SPS multicast transmission that the UE 102 successfully receives and from which the UE 102 obtains a transport block. In cases where the configuration parameters do not include the indication, the UE 102 can transmit to the DU 174 a HARQ ACK for an SPS multicast transmission that the UE 102 successfully receives and from which the UE 102 obtains a transport block.
HARQ ACK/NACK indication, which configures the UE 102 to transmit a HARQ NACK for an SPS multicast transmission where the UE 102 fails to obtain a transport block and configures the UE 102 to transmit a HARQ ACK for an SPS multicast transmission that the UE 102 successfully receives and from which the UE 102 obtains a transport block. In cases where the configuration parameters do not include the indication, the UE 102 refrains from transmitting to the DU 174 a HARQ ACK for an SPS multicast transmission that the UE 102 successfully receives and obtains a transport block. In such cases, the UE 102 is only allowed to transmit to the DU 174 a HARQ NACK for an SPS multicast transmission where the UE 102 fails to obtain a transport block.
HARQ ACK indication, which configures the UE 102 to transmit a HARQ ACK for an SPS multicast transmission that the UE 102 successfully receives and from which the UE 102 obtains a transport block. In cases where the configuration parameters do not include the indication, the UE 102 refrains from transmitting to the DU 174 a HARQ ACK for an SPS multicast transmission where the UE 102 successfully obtains a transport block. In such cases, the UE 102 is only allowed to transmit to the DU 174 a HARQ NACK for an SPS multicast transmission where the UE 102 fails to obtain a transport block. In some implementations, the DU 174 can include either one of the HARQ NACK indication, HARQ ACK/NACK indication and HARQ ACK indication.
Aggregation factor, which is the number of repetitions for SPS multicast transmission(s). The DU 174 can transmit (i.e., multicast) a number of repetitions of an SPS multicast transmission in accordance the aggregation factor, and the UE 102 receives the repetitions based on the aggregation factor. In cases where the DU 174 does not include the aggregation factor in the DU configuration, the UE 102 and DU 174 in some implementations can apply an aggregation factor for dynamic scheduling multicast transmission as described above. Alternatively, the UE 102 and DU 174 can apply an aggregation factor for unicast transmission(s). In some implementations, the UE 102 and DU 174 can apply an aggregation factor for unicast transmission(s) as described above.
MCS configuration, which indicates a MCS table that the DU 174 uses to transmit an SPS multicast transmission and the UE 102 uses to receive the SPS multicast transmission. For example, the MCS table can be a MCS table defined in 3GPP specification 38.214 (e.g., a low-SE 64QAM table indicated in Table 5.1.3.1-3 of 3GPP TS 38.214 or a new table specific for multicast transmission). In some implementations, if DU 174 does not include the MCS configuration in the DU configuration, the UE 102 and DU 174 can apply a MCS table predefined in 3GPP specification 38.214. For example, the predefined MCS table can be a 256QAM table or a 64QAM table, e.g., indicated in Table 5.1.3.1-2 or non-low-SE 64QAM table indicated in Table 5.1.3.1-1 of the specification 38.214, respectively. In cases where the DU 174 does not include the MCS configuration in the DU configuration, the UE 102 and DU 174 in other implementations can apply a MCS table for dynamic scheduling multicast transmission to receive SPS multicast transmissions from the DU 174 as described above. Alternatively, the UE 102 and DU 174 can apply a MCS table for unicast transmission to receive SPS multicast transmissions from the DU 174. In some implementations the UE 102 and DU 174 can apply a MCS table for unicast transmission to receive SPS multicast transmissions from the DU 174 as described above. In some implementations, the DU 174 can include, in the DU configuration, a PDSCH configuration (e.g., PDSCH-Config IE) configuring the MCS table for unicast transmissions. In other implementations, the DU 174 can transmit to the UE 102 another DU configuration including the PDSCH configuration, similar to events 516, 518, and 520.

In some implementations, the CU-CP 172A can include the MBS session join response message in the RRC reconfiguration message. The UE 102 can include the MBS session join complete message in the RRC reconfiguration complete message. Alternatively, the UE 102 can send a UL RRC message including the MBS session join complete message to the CU-CP 172A via the DU 174. The UL RRC message can be an ULInformationTransfer message or any suitable RRC message that can include a UL NAS PDU. The CU-CP 172A can include the MBS session join complete message in the second BS-to-CN message. Alternatively, the CU-CP 172A can send to the CN 110 a BS-to-CN message (e.g., an UPLINK NAS TRANSPORT message) including the MBS session join complete message.

In other implementations, the CU-CP 172A transmits a DL RRC message that includes the MBS session join response message to the UE 102. The DL RRC message can be a DLInformationTransfer message, another RRC reconfiguration message, or any suitable RRC message that can include a DL NAS PDU. The UE 102 can send a UL RRC message including the MBS session join complete message to the CU-CP 172A via the DU 174. The UL RRC message can be an ULInformationTransfer message, another RRC reconfiguration complete message or any suitable RRC message that can include a UL NAS PDU.

The events 532, 534, and 536 are collectively referred to in FIG. 5A as an MBS session data transmission procedure 596.

In cases where the CU-CP 172A does not receive slice information from the CN 110, the CU-CP 172A can include preconfigured slice information in the first CP-to-UP message of event 560. In cases where the CU-CP 172A does not receive slice information from the CN 110, the CU-CP 172A can include preconfigured slice information in the first CU-to-DU message of event 506.

FIG. 5B illustrates an example scenario 500B similar to the scenarios 500A illustrated in FIG. 5A with the differences as described below. In the scenario 500B, the events 504, 512, 514, 560, 562, 506, 508, 510, 564, 566, 516, 567, 568, and 518 are collectively referred to in FIG. 5B as an MBS session resource setup procedure 592B similar to event 592A. In some implementations, the event 560, 564, or 567 may (additionally or instead, compared to the ones in event 592A) contain MBS PDCP Configuration for setting up multicast bearer context for inactive state MRB(s) for multicast (i.e., MRB(s) configured for UEs operating in the inactive state) and contain NG-U transport information from the 5GC to the CU-UP 172B. The CU-CP 172A in response receives from the CU-UP 172B in the event 562, 566, or 568, the NG-U GTP DL TEID in case NG-U unicast transport was selected and an F1-U GTP UL TEID per MRB. In some implementations, the event 506 may (additionally or instead, compared to the ones in event 592A) contain an MBS CU to DU RRC Information which contains an MBS Multicast MRB List IE. The MBS Multicast MRB List IE contains a list of MBS Multicast MRB Item containing MRB ID and MRB PDCP Config Broadcast (e.g., MRB-PDCP-ConfigBroadcast IE, as defined in TS 38.331) for an Inactive state multicast MRB. The DU 174 in response generates an MBS muticast configuration (e.g., MBSMulticastConfiguration IE) including an MBS-SessionInfoList which contains, for each of the MBS session, the MRB PDCP Config Broadcast and an MRB RLC Config Broadcast (e.g., MRB-RLC-ConfigBroadcast IE, as defined in TS 38.331) and/or an MCCH configuration for inactive state multicast MRB(s). The DU 174 may include the MBS muticast configuration and/or the MCCH configuration in the event 508 to the CU-CP 172A.

In the scenario 500B, the CN 110, CU-CP 172A, DU 174, and UE 102 in some implementations perform 594 the UE-specific MBS session configuration procedure if the UE 102 is configured to receive multicast data in the connected state. In such case, the CN 110, CU-UP 172B, DU 174 and UE 102 perform 596 the MBS data transmission for the first MBS session. In other implementations, the BS 104 decides to only configure the UEs to receive multicast data in the inactive state. In such case, in the event 592B, only the inactive state multicast MRB configuration and resources are established in the BS 104. The events 594 and 596 are skipped in such case as well. After the event 592B, the CU-CP 172A maycan decide 542 to transition the UE 102 to inactive state. The CU-CP 172A maycan send 544 a Bearer Context Modification Request message with a Bearer Context Status Change IE to the CU-UP 172B, which indicates that the UE 102 is entering RRC inactive state. The CU-UP 172B in response suspends the DRB(s) and/or MRB(s) for the UE operating in the connected state and sends 546 a Bearer Context Modification Response message to the CU-CP 172A. The CU-CP 172A sends 552 a CU-to-DU message (e.g., a UE Context Release Command message, a UE Context Modification Request message or a DL RRC Message Transfer message) including an RRC release (e.g., RRCRelease) message to the DU 174. The CU-CP 172A includes in the RRC release message a suspend configuration. The CU-CP 172A includes in the suspend configuration a multicast configuration for inactive (e.g., MulticastConfigInactive) which maymay further include the MBS muticast configuration and/or the MCCH configuration that the CU-CP 172A received from the DU 174. The DU 174 in response sends 554 the RRC release message to the UE 102.

In some implementations, the MulticastConfigInactive IE/field is as below and the respective IEs with suffix r17 are defined in the TS 38.331v17.0 and its later version.

| MulticastConfigInactive-r18::= | | SEQUENCE { |
|---|---|---|
| mbs-ServiceList-r18 | MBS-ServiceList-r18, | OPTIONAL -- Need N |
| servCellId-r17 | ServCellIndex, | OPTIONAL -- Need N |

| | |
|---|---|
| servingCellPTM-Config | OCTET STRING (CONTAINING MBSMulticastConfiguration), OPTIONAL -- |

Need N

| | |
|---|---|
| mcch-Config | OCTET STRING (CONTAINING SystemInformation) OPTIONAL-- Need N |

}

| | |
|---|---|
| MBS-ServiceList-r18 ::- | SEQUENCE (SIZE (1..maxNrofMBS-ServiceListPerUE-r17)) OF MBS- |

ServiceInfo-r18

| | |
|---|---|
| MBS-ServiceInfo-r18 ::= | SEQUENCE { |
| tmgi-r18 | TMGI-r17, |
| serviceStatus | ENUMERATED {active, inactive} |

}

In some implementations, the MBSMulticastConfiguration IE is as below.

MBSMulticastConfiguration-r18 ::= SEQUENCE {

| | |
|---|---|
| criticalExtensions | CHOICE { |
| mbsMulticastConfiguration-r18 | MBSMulticastConfiguration-r18-IEs, |
| criticalExtensionsFuture | SEQUENCE { } |

}
}
MBSMulticastConfiguration-r18-IEs ::= SEQUENCE {

| | |
|---|---|
| mbs-SessionInfoList-r18 | MBS-SessionInfoList-r17 |

OPTIONAL, -- Need R

| | |
|---|---|
| mbs-NeighbourCellList-r18 | MBS-NeighbourCellList-r17 |

OPTIONAL, -- Need S

| | |
|---|---|
| drx-ConfigPTM-List-r18 | SEQUENCE (SIZE (1..maxNrofDRX-ConfigPTM-r17)) OF DRX- |

ConfigPTM-r17 OPTIONAL, -- Need R

| | |
|---|---|
| pdsch-ConfigMTCH-r18 | PDSCH-ConfigBroadcast-r17 |

OPTIONAL, -- Need S

| | |
|---|---|
| match-SSB-MappingWindowList-r18 | MTCH-SSB-MappingWindowList-r17 |

OPTIONAL, -- Need R

| | |
|---|---|
| lateNonCriticalExtension | OCTET STRING |

OPTIONAL,

| | |
|---|---|
| nonCriticalExtension | SEQUENCE { } |

OPTIONAL
}

The events 502, 592B, 503, 594, 596, 542, 544, 546, 552 and 554 are collectively referred to in FIG. 5B as an MBS session resources configuration and RRC state transition procedure 590. The events 542, 544, 546, 552 and 554 are collectively referred to in FIG. 5B as an RRC state transition procedure 588.

In response to the RRC release message, the UE 102 transitions 556 to the inactive state and applies the suspend configuration. If the UE 102 in the connected state is receiving multicast via the connected state MRB(s), the UE 102 suspends the connected state MRB(s) and/or other unicast DRB(s) if configured. In some implementations, the UE 102 does not suspend the connected state MRB(s) as they are the same as the inactive state MRB(s) or essentially operable irrespective of the states. If the UE 102 does not receive MBS muticast configuration and/or MCCH configuration in the RRC release message, the UE 102 may transmit 570 a system information request message to the DU 174 to request system information including a MCCH configuration for MBS multicast. In some implementations, the system information request message is a random access preamble. In other implementations, the system information request message can be an RRC message (e.g., RRCSystemInfoRequest message and the DU 174 sends the system information request message to the CU-CP 172A. The CU-CP 172A in response sends 572 a CU-to-DU message (e.g., System Information Delivery Command message) to request/enable the DU 174 to broadcast the requested the SIB (e.g., SIB22 or SIB23) containing a MCCH configuration (e.g., mcch-Config-r18) for MBS multicast or a System Information message including the SIB. After (e.g., in response to) receiving the system information request message or the CU-to-DU message 572, the DU 174 broadcasts 538 the SIB. In some implementatoins, the DU 174 includes the SIB in a SystemInformation message and broadcasts 538 the SystemInformation message. After transmitting the system information request message, the UE 102 attempts receives the SIB or the SystemInformation message and receive 538 the SIB or the SystemInformation message. After receiving the SIB, the UE 102 according to the MCCH configuration received in the SIB receives 540 the MBSMulticastConfiguration on the MCCH.

In some implementations, the SIB also includes a common frequency resources configuraton (e.g., cfr-ConfigMCCH-MTCH-r18). An implementation of the SIB (e.g., SIBx-r18, where x can be 22, 23, 24, 25, or 26) in RRC ASN.1 is as shown below.

SIBx-r18 ::= SEQUENCE {

| mcch-Config-r18 | MCCH-Config-r17, | |
|---|---|---|
| cfr-ConfigMCCH-MTCH-r18 | CFR-ConfigMCCH-MTCH-r17 | OPTIONAL, -- Need S |
| lateNonCriticalExtension | OCTET STRING | OPTIONAL, |

...
}

After receiving the MBS muticast configuration in event 554 or 540, the UE 102 establishes inactive state MRB(s) to receive MBS data in accordance with the MBS multicast configuration for inactive state. The UE 102 maycan start to receive 558 MBS data on the inactive state MRB(s). In some implementations, the CU-CP 172A can indicate the first MBS session or MBS service(s) associated with the first MBS session is active or inactive in the RRC release message or MBS muticast configuration. In other implementations, the DU 174 can indicate the first MBS session or MBS service(s) associated with the first MBS session is active or inactive in the MBS muticast configuration. If the RRC release message or the MBS multicast configuration for inactive state indicates that the first MBS session or MBS service(s) associated with the first MBS session is active, the UE 102 starts to receive 558 MBS data associated with the first MBS session. Otherwise, if the RRC release message or the MBS multicast configuration for inactive state indicates that the first MBS session or MBS service(s) associated with the first MBS session is inactive, the UE 102 refrains from starting to receive or refrains from receiving MBS data associated with the first MBS session. When the first MBS session or MBS service(s) associated with the first MBS session is inactive, the CN 110 may send 574 a Multicast Session Activation message to the CU-CP 172A to notify that the first MBS session is activated or to be activated. The CU-CP 172A in response sends 576 a multicast group notification message (e.g., Multicast Group Paging message) to the DU 174. The DU 174 sends 578 a multicast group notification message (e.g., (RRC) Paging message) to the UE 102. In some implementations, the CU-CP 172A includes the first MBS session ID (e.g., Temporary Mobile Group Identity (TMGI)) in the mulitast group notification message 576 and the DU 174 includes the first MBS session ID in the multicast group notification message 578.

After the UE 102 transitions to the inactive state, the CN 110 (e.g., the UPF 162) sends 559 a MBS data of the first MBS session to the CU-UP 172B. The CU-UP 172B then sends 561 the MBS data to the DU 174 and the DU 174 multicasts 563 the MBS data to the UE 102. In the case that the CN 110 transmits 574 the Multicast Session Activation message, the CN 110 transmits 559 the MBS data after transmitting the Multicast Session Activation message. The UE 102 receives 563 the MBS data on the inactive state MRB(s) in accordance with the MBS multicast configuration received in event 554 or 540.

The events 556, 570, 571, 572, 538, 540, 558, 574, 576, 578, 559, 561, and 563 are collectively referred to in FIG. 5B as an MBS data transmission for the first MBS session 597.

In some implementations, if the RRC release message does not include the MBS multicast configuration, the UE 102 in the inactive state continues 558 receiving MBS data on the connected state MRB(s) of the first MBS session from the DU 174, before receiving the MBS multicast configuration 540. In such implementations, the UE 102 in the inactive state continues 558 receiving or attempting to receive MBS data of the first MBS session from the DU 174 in accordance with the first multicast configuration parameters. In such implementations, the UE 102 refrains from suspending the MRB(s) and/or PDCP entity/entities associated with the connected state MRB(s) to continue 558 receiving MBS data of the first MBS session via the connected state MRB(s). In such implementations, the UE 102 refrains from resetting the MAC entity, in response to the RRC release message, to continue 558 receiving MBS data of the first MBS session via the MAC entity.

In other implementations, the UE 102 stops or suspends receiving MBS data on the connected state MRB(s) from the DU 174 (e.g., the UE 102 suspends the connected state MRB(s)), in response to the RRC release message or transitioning 556 to the inactive state. In such implementations, the UE 102 in the inactive state may stop using the first multicast configuration parameters (e.g., G-RNTI and/or G-CS-RNTI to monitor a PDCCH) in response to or when stopping or suspending receiving MBS data. When the DU 174 receives MBS data (e.g., event 561), the DU 174 can transmit (e.g., multicast or broadcast) 578 the multicast group notification message to the UE 102 to indicate the UE 102 to receive MBS data of the first MBS session. After (e.g., in response to) receiving the multicast group notification message 578, the UE 102 in the inactive state can start or attempt to receive MBS data of the first MBS session.

Depending on the implementation, in response to the CU-to-DU message of event 552, the DU 174 retains the multicast configuration parameter(s) for inactive state MRB(s) and/or for connected state MRB(s) and can release unicast configuration parameters (i.e., configuration parameters for unicast communication) that the DU 174 configures for the UE 102. In some implementations, if all the UEs interested in receiving MBS data are transitioned to inactive state, the DU 174 may be able to release the multicast configuration parameter(s) for connected state MRB(s). The CU-CP 172A may indicate so in the Multicast Context Release Command message or in the Multicast Context Modification Request message by listing the concerned MRB ID(s) to the DU 174. In some implementations, the DU 174 can send a DU-to-CU message (e.g., a UE Context Release Complete message or a UE Context Modification Response message) to the CU-CP 172A in response to the CU-to-DU message of event 552.

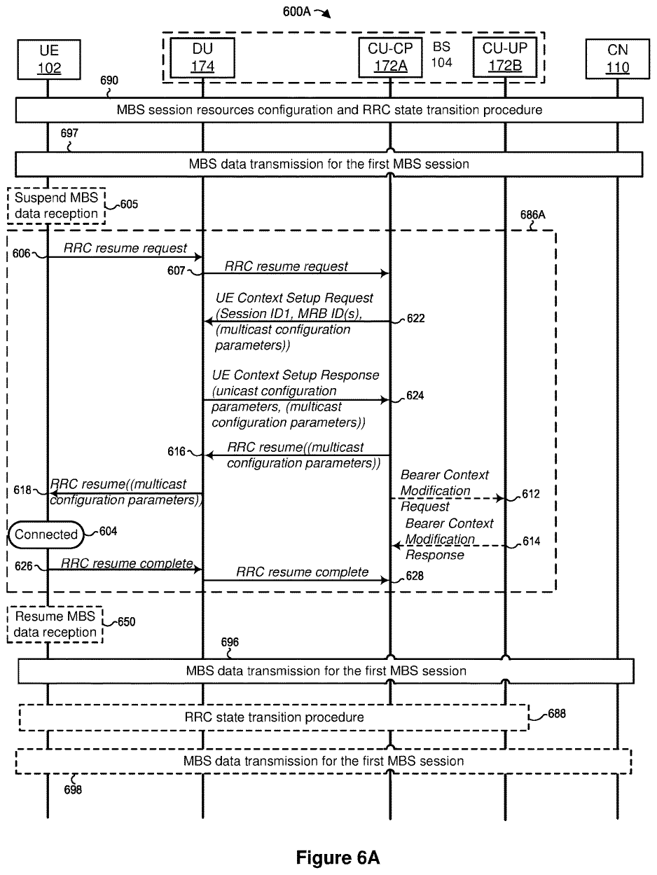

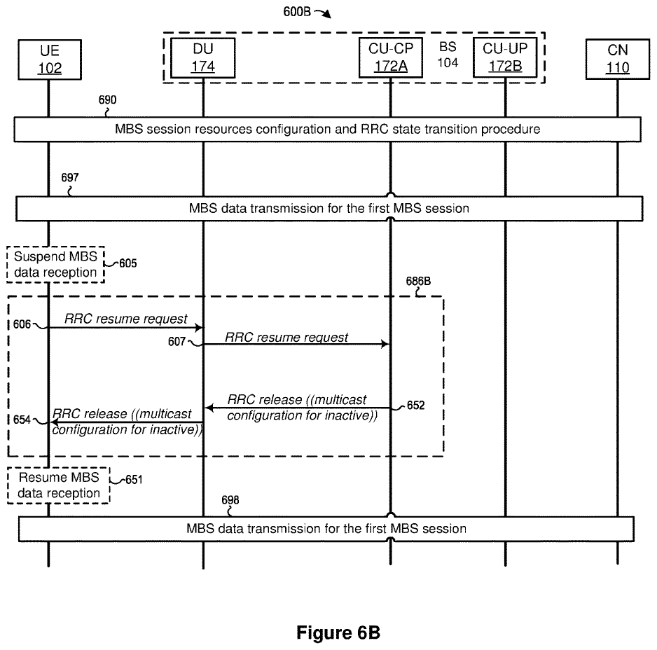

FIG. 6A illustrates an example scenario 600A in which the base station 104 manages transmission of downlink data for a MBS session (e.g., the first MBS session described for FIGS. 5A-5B) to the UE 102 operating in the inactive state and connected state. The base station 104 includes a DU 174, CU-CP 172A and CU-UP 172B. Events in this scenario similar to those discussed above are labeled with similar reference numbers (e.g., events 622, 624, 697, 696, 698, 688, and 690 are similar to the events 522, 524, 596, 597, and 588, and 590), and the examples and implementations for FIGS. 5A-5B can apply to FIG. 6A. The differences between the scenario 600A of FIG. 6A and the scenarios 500A-B of FIGS. 5A-B are discussed below.

In the scenario 600A, the UE 102, BS 104, and the CN 110 initially perform 690 the MBS session resources configuration and RRC state transition procedure. While the UE 102 operates in the inactive state, the CN 110 and the base station 104 perform 697 MBS data transmission for the first MBS session with the UE 102. At a later time, the UE 102 operating in the inactive state initiates an RRC connection resume procedure with the DU 174 via a cell (e.g., cell 124). In some implementations, the UE 102 initiates the RRC connection resume procedure to transmit unicast data (e.g., data associated to a SRB or DRB). In other implementations, The UE 102 receives a paging message from the DU 174 and initiates the RRC connection resume procedure in response to the paging message. In yet other implementations, the UE 102 initiates the RRC connection resume procedure for a periodic RAN notification area (RNA) update.

In response to initiating the RRC connection resume procedure, the UE 102 transmits 606 an RRC resume request message (e.g., RRCResumeRequest message) to the DU 174. In some implementations, the UE 102 performs a random access procedure with the DU 174 via the cell to transmit the RRC resume request message. In some implementations, the random access procedure can be a two-step random access procedure and the UE 102 transmits a Message A including the RRC resume request message to the DU 174 in the random access procedure. In other implementations, the random access procedure is a four-step random access procedure and the UE 102 transmits a Message 3 including the RRC resume request message to the DU 174 in the random access procedure. The DU 174 in turn transmits 607 an Initial UL RRC Message Transfer message including the RRC resume request to the CU-CP 172A. In some implementations, the UE 102 suspends 605 the MBS data reception for the first MBS session in response to the initiation. In other implementations, the UE 102 does not suspend the MBS data reception for the first MBS session during or after initiating the RRC connection resume procedure.

After (e.g., in response to) receiving the RRC resume request message at event 607, the CU-CP 172A sends 622 a first CU-to-DU message (e.g., UE Context Setup Request message) to the DU 174. In some implementations, the CU-CP 172A includes the first MBS session ID (e.g., MBS Session ID 1), and/or MRB ID(s) in the first CU-to-DU message, similar to the event 522. In some implementations, the CU-CP 172A can include first multicast configuration parameters in the first CU-to-DU message. In some implementations, the first multicast configuration parameters includes multicast configuration parameters that the UE 102 and DU 174 used for multicast communication at event 697. In some implementations, the first multicast configuration parameters include multicast configuration parameters that the UE 102 and DU 174 used for multicast communication (e.g., communicating MBS data of the first MBS session) while the UE 102 operated in a connected state. In some further implementations, the CU-CP 172A can include, in the first CU-to-DU message, first unicast configuration parameters that the UE 102 and DU 174 used for unicast communication while the UE 102 operated in the connected state. In some implementations, the first unicast configuration parameters include configuration parameters included in a CellGroupConfig IE and defined for unicast communication. In some implementations, the first multicast configuration parameters include configuration parameters included in a CellGroupConfig IE and defined for multicast communication. In some implementations, the CU-CP 172A can include the first unicast configuration parameters and first multicast configuration parameters in a first container IE (e.g., a CU to DU RRC Information IE or a first CellGroupConfig IE) and include the first container IE in the first CU-to-DU message.

In response to the first CU-to-DU message of event 622, the DU 174 sends 624 to the CU-CP 172A a first DU-to-CU message (e.g., UE Context Setup Response message) including second unicast configuration parameters. In some implementations, the DU 174 generates the second unicast configuration parameters to augment the first unicast configuration parameters. In such implementations, the second unicast configuration parameters are a delta configuration on top of the first unicast configuration parameters. In other implementations, the DU 174 generates the second unicast configuration parameters to replace the first unicast configuration parameters. In such implementations, the second unicast configuration parameters are a full configuration (i.e., a complete and self-contained configuration). In some implementations, the DU 174 includes, in the UE Context Setup Response message, second multicast configuration parameters for the UE 102 to receive MBS data of the first MBS session. In some implementations, the DU 174 generates the second multicast configuration parameters to augment the first multicast configuration parameters. In such implementations, the second multicast configuration parameters are a delta configuration on top of the first multicast configuration parameters. In other implementations, the DU 174 generates the second multicast configuration parameters to replace the first multicast configuration parameters. In such implementations, the second multicast configuration parameters are a full configuration (i.e., a complete and self-contained configuration). In some implementations, the second unicast configuration parameters include configuration parameters included in a CellGroupConfig IE and defined for unicast communication. In some implementations, the second multicast configuration parameters include configuration parameters included in a CellGroupConfig IE and defined for multicast communication. In some implementations, the CU-CP 172A can include the second unicast configuration parameters and second multicast configuration parameters in a second container IE (e.g., a CU to DU RRC Information IE or a first CellGroupConfig IE) and include the second container IE in the first DU-to-CU message. In some implementations, examples and/or implementations of the multicast configuration parameters described for FIGS. 5A-5B are applied to the first and/or second multicast configuration parameters. In other implementations, if the DU 174 determines that the first multicast configuration parameters are still suitable for multicast communication with the UE 102, the DU 174 does not include multicast configuration parameters (e.g., the second multicast configuration parameters) in the first DU-to-CU message. Similarly, if the DU 174 determines that the first unicast configuration parameters are still suitable for unicast communication with the UE 102, the DU 174 does not include unicast configuration parameters (e.g., the second unicast configuration parameters) in the first DU-to-CU message.

After receiving 624 the first DU-to-CU message, the CU-CP 172A generates an RRC resume message (e.g., RRCResume message). In cases where the first DU-to-CU message includes the second unicast configuration parameters and/or second multicast configuration parameters, the CU-CP 172A includes the second unicast configuration parameters and/or second multicast configuration parameters in the RRC resume message. If the CU-CP 172A determines to configure or reconfigure MRB(s) for the first MBS session, the CU-CP 172A can include a MRB configuration in the RRC resume message to configure or reconfigure the MRB(s). Otherwise, the CU-CP 172A does not include a MRB configuration in the RRC resume message. The CU-CP 172A then transmits 616 a second CU-to-DU message (e.g., DL RRC Message Transfer message) including the RRC resume message to the DU 174. In turn, the DU 174 transmits 618 the RRC resume message to the UE 102. In response to the RRC resume message, the UE 102 transitions 604 to the connected state from the inactive state. The UE 102 in the connected state then transmits 626 an RRC resume complete message (e.g., RRCResumeComplete message) to the DU 174, which in turn sends 628 a second DU-to-CU message (e.g., an UL RRC Message Transfer message) including the RRC resume complete message to the CU-CP 172A. Events 606, 607, 622, 624, 616, 618, 612, 614, 604, 626 and 628 are grouped as an RRC connection resume procedure (with a state transition) 686A.

After (e.g., in response to) receiving the first DU-to-CU message or transmitting the RRC resume message, the CU-CP 172A may send 612 a CP-to-UP message (e.g., Bearer Context Modification Request message) to the CU-UP 172B to resume DRB(s) that the CU-CP 172A configures for the UE 102 (i.e., for unicast communication with the UE 102). In some implementations, in cases where the CU-CP 172A does not configure a DRB for the UE 102 and configures MRB(s) for the UE 102, the CU-CP 172A may refrain from transmitting the CP-to-UP message to the CU-UP 172B. In other implementation, in cases where the CU-CP 172A does not configure a DRB for the UE 102 and configures MRB(s) for the UE 102, the CU-CP 172A still transmits the CP-to-UP message to the CU-UP 172B to resume the connected state MRB(s) for the UE 102. If the CU-CP 172A configures DRB(s) for the UE 102, the CU-CP 172A can include DRB ID(s) of the DRB(s) in the CP-to-UP message to resume the DRB(s). In response to the CP-to-UP message, the CU-UP 172B sends 614 an UP-to-CP message (e.g., Bearer Context Modification Response message) to the CU-CP 172A. In some implementations, the CU-UP 172B can include, in the UP-to-CP message, DRB ID(s) of the DRB(s) to indicate that the DRB(s) are resumed successfully, respectively.

In cases where the UE 102 suspends the MBS data reception at event 605, the UE 102 in the connected state resumes 650 receiving MBS data of the first MBS session on connected state MRB(s) from the DU 174 (e.g., the UE 102 resumes the connected state MRB(s)), after (e.g., in response to) receiving the RRC resume message while the configuration and resources (e.g., variables for storing the configuration) for the inactive state MRB(s) are released. In some implementations, the configurations for connected state MRB(s) and the inactive state MRB(s) are the same or essentially operable irrespective of the states. In such a case, the UE 102 can continues to receive MBS data on the inactive state MRB(s). After that, the CN 110 and base station 104 perform 696 MBS data transmission for the first MBS session with the UE 102 operating in the connected state. In cases where the UE 102 does not suspend the MBS data reception after (e.g., in response to) initiating the RRC connection resume procedure, the UE 102 can continue to perform or performs the MBS data reception for the first MBS session during or after the RRC connection resume procedure (i.e., the configuration and resources (e.g., variables for storing the configuration) for the inactive state MRB(s) are not released). Depending on the implementation, the UE 102 in the connected state performs multicast communication with the DU 174 (e.g., including receiving MBS data of the first MBS session) in accordance with the first multicast configuration parameters, the second multicast configuration parameters, or the second multicast configuration parameters and/or configuration parameters, of the first multicast configuration parameters, not augmented by the second multicast configuration parameters. Similarly, depending on the implementation, the UE 102 in the connected state perform unicast communication with the DU 174 in accordance with the first unicast configuration parameters, the second unicast configuration parameters, or the second unicast configuration parameters and/or configuration parameters, of the first unicast configuration parameters, not augmented by the second unicast configuration parameters.

The base station 104 and the UE 102 may later perform 688 an RRC state transition procedure similar to event 588 as described in FIG. 5B. The UE 102 transitions to an inactive state after (e.g., in response to) performing the RRC state transition procedure at event 688. After the UE 102 transitions to the inactive, the UE 102 may perform or continue to perform the MBS data reception based on the configured inactive state MRB(s) if the configurations are maintained after the state transitions during event 686A and event 688. The CN 110 and base station 104 then perform 698 MBS data transmission for the first MBS session with the UE 102 operating in the inactive state.

FIG. 6B illustrates an example scenario 600B, similar to the scenario 600A, in which the base station 104 remains the UE 102 in the inactive state in the RRC connection resume procedure instead of transitioning the UE 102 to the connected state. The differences between the scenario 600B of FIG. 6B and the scenario 600A of FIG. 6A are discussed below.

Unlike the scenario 600A, the CU-CP 172A in the scenario 600B, after receiving the RRC resume request message at event 607, refrains from performing a Bearer Context Modification procedure (e.g., events 612 and 614) with the CU-UP 172B and a UE context setup procedure (e.g., events 622 and 624) with the DU 174. The CU-CP 172A maintains the multicast configuration for inactive which is prepared during the event 690 similar to as described in the event 590. The CU-CP 172A sends 652 an RRC release message including a suspend configuration to the DU 174. The DU 174 then sends the RRC release message to the UE 102. In some implementations, the CU-CP 172A includes in the RRC release message the multicast configuration for inactive or a delta version (i.e., only the parameters which is changed by the CU-172A and/or the DU 174 since the last configuration to the UE 102) of the multicast configuration for inactive. In other implementations, CU-CP 172A refrain from including in the RRC release message the multicast configuration for inactive or a delta version of the multicast configuration for inactive. After receiving the RRC release message, the UE 102 resumes 651 the MBS data reception. In some implementations, the UE 102 resumes the MBS data reception by releasing the existing inactive state MRB(s) and setting up new MRB(s) according to the received multicast configuration for inactive. In other implementations, the UE 102 resumes the MBS data reception by reusing the existing multicast configuration on the existing inactive MRB(s) if it does not received a multicast configuration for inactive in the RRC release message. In yet another implementations, the UE 102 resumes the MBS data reception on the existing inactive state MRB(s) by augmenting the received multicast configuration for inactive. After enabling the MBS data reception on the inactive state MRB(s), the CN 110, CU-UP 172B, DU 174 and the UE 102 performs 698 the MBS data transmission for the first MBS session.

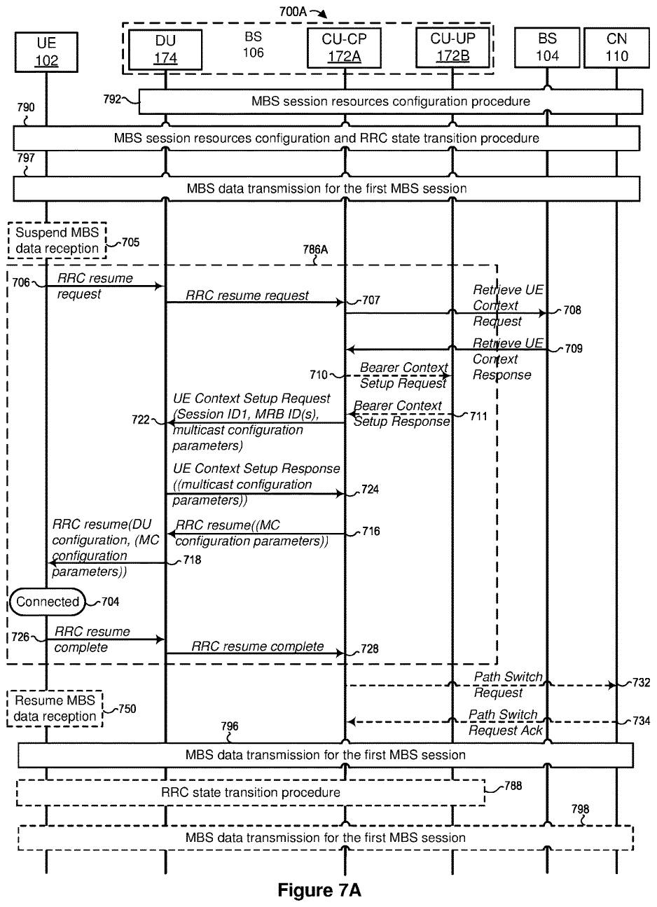

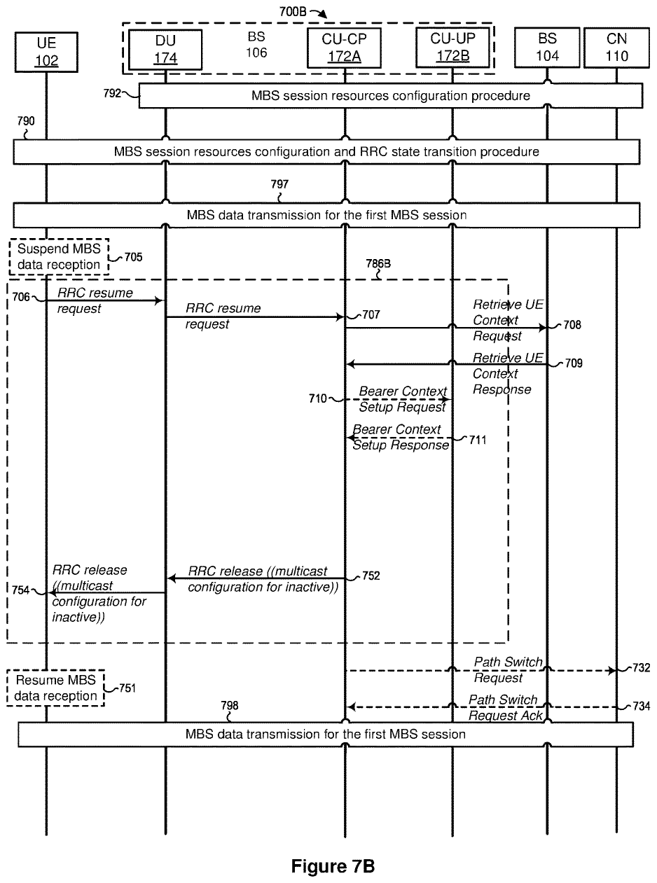

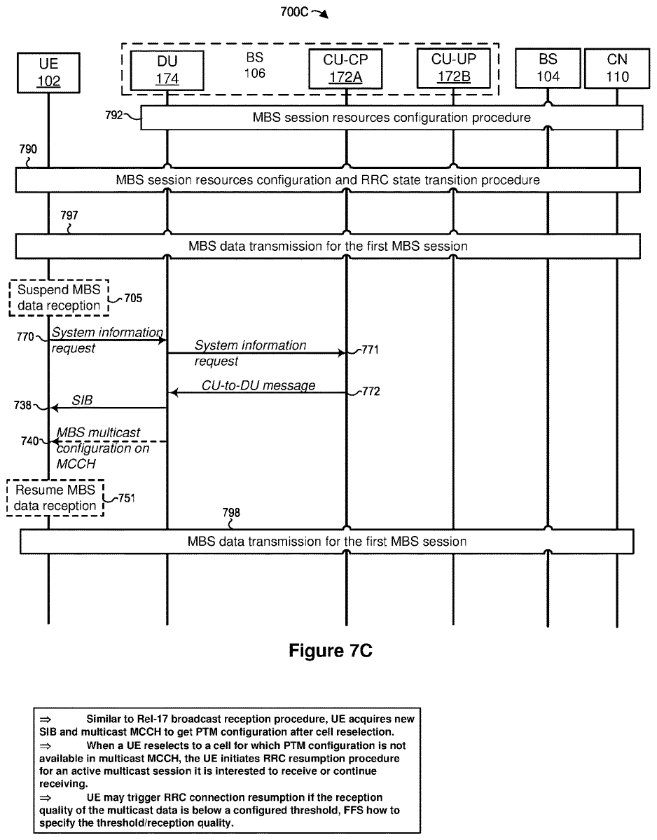

Turning next to FIG. 7A, which illustrates an example scenario 700A, similar to the scenario 600A, in which the UE 102 in the inactive state is receiving MBS data of a MBS session (e.g., the first MBS session described for FIGS. 5A-5E) from the base station 104 and moves to coverage of the base station 106. The base station 106 includes a DU 174, CU-CP 172A and CU-UP 172B. Events in this scenario similar to those discussed above are labeled with similar reference numbers, and the examples and implementations for FIGS. 5A-5B and 6A can apply to FIG. 7A. The differences between the scenario 700A of FIG. 7A and the scenario 600A of FIG. 6A are discussed below.

In the scenario 700A, the CN 110 and the base station (BS) 106 initially perform 792 a MBS session resources configuration procedure similar to the event 592A or 592B. The UE 102 initially performs 790 with the BS 104 and the CN 110 the MBS session resources configuration and RRC state transition procedure. The UE 102 is configured to receive MBS data in inactive state. The CN 110, BS 104, and the UE 102 performs 797 MBS data transmission for the first MBS session while the UE 102 operates in an inactive state. At a later time, the UE 102 in the inactive state performs cell selection or reselection to a cell (e.g., cell 126) of the BS 106. The UE 102 suspends 705 the MBS data reception similar to the event 605. The UE 102 initiates an RRC connection resume procedure with the BS 106 via the cell. In some implementations, the UE 102 generates an RRC resume request message including a resume cause indicating that the resumption of the RRC connection is triggered due to multicast reception request (e.g., set the resumeCause to emergency or select a corresponding Access Category). In response to initiating the RRC connection resume procedure, the UE 102 transmits 706 the RRC resume request message (e.g., RRCResumeRequest message) to the DU 174 of the BS 106 and the DU 174 in turn transmits 707 the RRC resume request message to the CU-CP 172A of the BS 106. After (e.g., in response to) receiving the RRC resume request message, the CU-CP 172A sends 708 a Retrieve UE Context Request message to the base station 104 (e.g., a CU-CP of the base station 104). In response, the base station 104 sends 709 a Retrieve UE Context Response message including a UE context of the UE 102 to the CU-CP 172A. In some implementations, the UE context include multicast configuration parameters for inactive state or indication(s) that the UE was configured with multicast configuration parameters for inactive state on some MBS session(s) (e.g., identified by TMGI) and unicast configuration parameters that the base station 104 configured for the UE 102 for multicast communication for inactive state and unicast communication, respectively. In some implementations, the base station 104 includes, in the Retrieve UE Context Response message, DRB information including DRB ID(s) identifying DRB(s) that the base station 104 configures for the UE 102.

After receiving the Retrieve UE Context Response message, the CU-CP 172A can send 710 a CP-to-UP message (e.g., Bearer Context Setup Request message) to the CU-UP 172B to establish a bearer context for the DRB(s) and MRB(s). In response, the CU-UP 172B establishes a bearer context for the DRB(s) and MRB(s) and sends 711 an UP-to-CP message (e.g., Bearer Context Setup Response message) to the CU-CP 172A. The CU-CP 172A performs event 722 and 724 UE Context Setup procedure with the DU 174 similar to events 522-524 or 622-624. After transmitting the RRC resume message at event 716 or receiving the RRC resume complete message at event 728, the CU-CP 172A can send 732 a Path Switch Request message to the CN 110 to switch of downlink termination point of a NG-U tunnel, associated to the UE 102, towards the CU-CP 172A. In response, the CN 110 sends 734 a Path Switch Response message to the CU-CP 172A.

Events 706, 707, 710, 711, 722, 724, 716, 718, 704, 726 and 728 are grouped as an RRC connection resume procedure (with a state transition) 786A.

The UE 102 after transitioning to the connected state establishes the connected state MRB(s) according to the configuration received at the event 718 and resumes 750 MBS data reception on the connected state MRB(s). In some implementation, the UE 102 releases the previous configured inactive state MRB(s). The BS 106 and the UE 102 may later perform 788 an RRC state transition procedure similar to the event 588. The UE 102 is then configured to resume MBS data reception on inactive MRB(s) with the BS 106 as with the BS 104 described in FIG. 5B or FIG. 6B. The CN 110, BS 106 and the UE 102 can then perform 798 MBS data transmission for the first MBS session similar to the event 597 or 698.

FIG. 7B illustrates an example scenario 700B similar to the scenarios 700A and 600B in which the UE 102 in the inactive state is receiving MBS data of a MBS session (e.g., the first MBS session described for FIGS. 5A-5B) from the base station 104 and moves to coverage of the base station 106, and the base station 106 remains the UE 102 in the inactive state in the RRC connection resume procedure instead of transitioning the UE 102 to the connected state. Events in this scenario similar to those discussed in FIGS. 7A and 6B are labeled with similar reference numbers, and the examples and implementations for FIGS. 7A and 6B can apply to FIG. 7B. The differences among FIGS. 7A, 7B and 6B are discussed below.

Before receiving the RRC resume request message at event 706 or 707, the base station 106 perform 792 a MBS session resources configuration procedure with the CN 110 to configure radio resources for the first MBS session, similar to the procedure 592A or 592B. After configuring the radio resources for the first MBS session, the base station 106 can transmit (e.g., multicast) MBS data of the first MBS session to UEs, operating in the inactive state or connected state, via one or more cells (e.g., cell 126). After the UE 102 performs 786B the RRC connection resume procedure without a state transition with the base station 106, the CN 110 and base station 106 then perform 798 MBS data transmission for the first MBS session with the UE 102 operating in the inactive state. The UE 102 suspends 705 MBS data reception when it reselects to the BS 106 and establishes the inactive state MRB(s) according to the configuration or information received through the events 752-754 as described in the FIGS. 5B and 6B. The UE 102 resumes 751 MBS data reception on the configured inactive state MRB(s).

In cases where the Retrieve UE Context Response message includes the DRB information for the UE 102, the CU-CP 172A can include, in the Bearer Context Setup Request message of event 710, a suspend indication (e.g., a Bearer Context Status Change IE) indicating the CU-UP 172B to suspend the DRB(s) for the UE 102. The CU-UP 172B suspends the DRB(s) for the UE 102 in response to the suspend indication. In cases where the Retrieve UE Context Response does not include DRB information for the UE 102, the CU-CP 172A refrains from sending a Bearer Context Setup Request message to the CU-UP 172B. In such cases, the events 710 and 711 are omitted.

Events 706, 707, 712, 752, and 754 are collectively referred in FIG. 7B as an RRC connection resume procedure (without a state transition) 786B.

FIG. 7C illustrates an example scenario 700C similar to the scenarios 700A, 700B and 600C. Events in this scenario similar to those discussed in FIGS. 7A, 7B and 6C are labeled with similar reference numbers, and the examples and implementations for FIGS. 7A, 7B and 6C can apply to FIG. 7C.

In the scenario 700C, after reselecting to the cells served by the BS 106, the UE 102 suspends 705 the MBS data reception. Instead of initiating connection resumption as in FIGS. 6A-B and 7A-B, in some implementations, the UE 102 checks the SIBI broadcasted by the BS 106 and may send 770 a System information request message (e.g., RRCSystemInfoRequest message) to request the information required to acquire the MCCH configuration for MBS multicast in inactive state to the DU 174 of the BS 106. The DU 174 forwards 771 the System information request message (e.g., in an Initial UL RRC Message Transfer message) to the CU-CP 172A. The CU-CP 172A in response may send 772 a CU-to-DU message (e.g., System Information Delivery Command) to request the DU 174 to broadcast the exact SIB for inactive state for multicast in System Information messages. The DU 174 broadcasts 738 one or more System Information messages containing the exact SIB in the cell. The UE 102 acquires the SIB and may obtain 740 the MBS multicast configuration on MCCH similar to the event 540. The UE 102 according to the MBS multicast configuration for inactive state establishes the inactive state MRB(s) for receiving multicast data. The UE 102 resumes 751 to receive MBS data on inactive state MRB(s) from the BS 106.

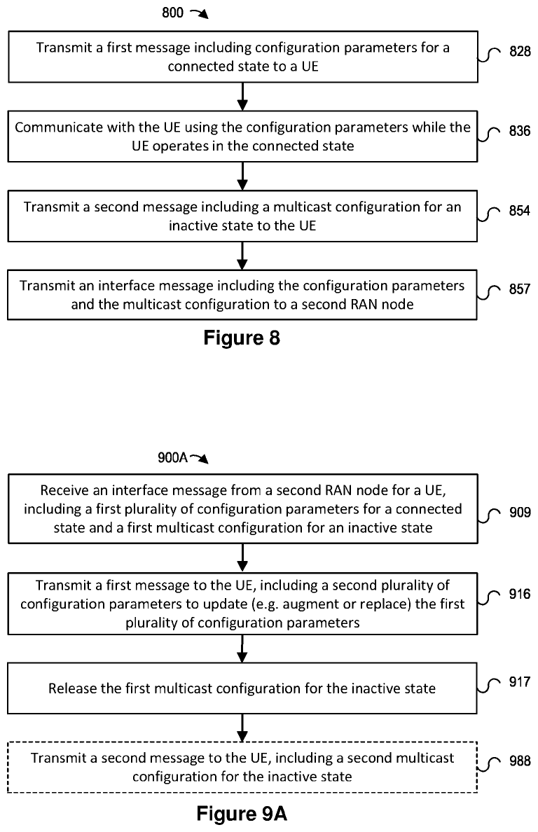

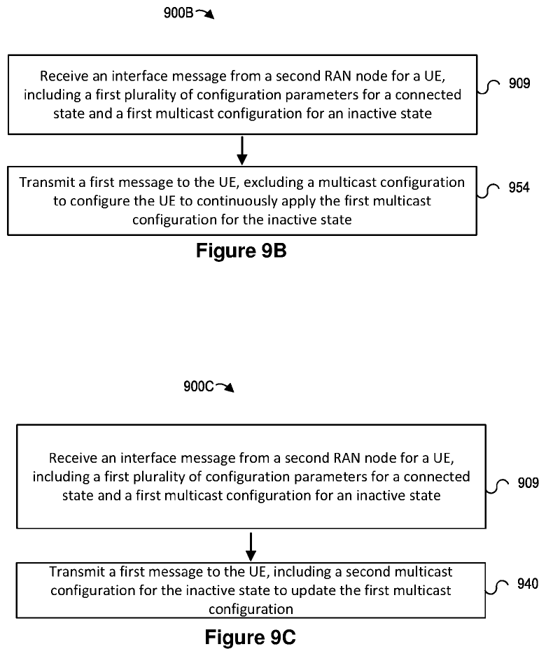

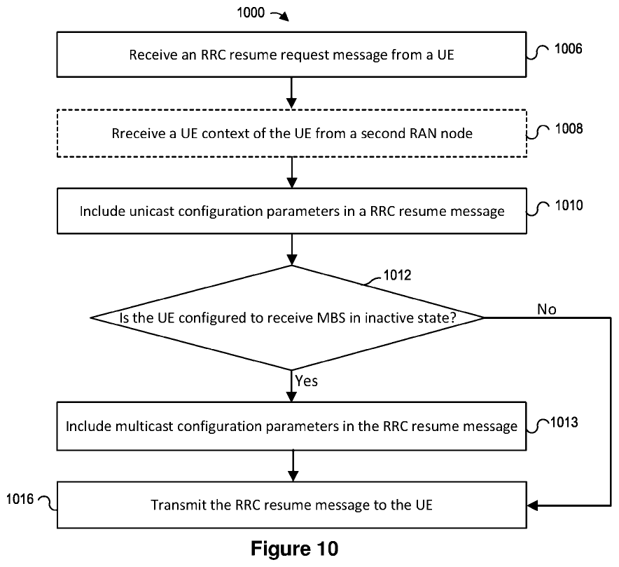

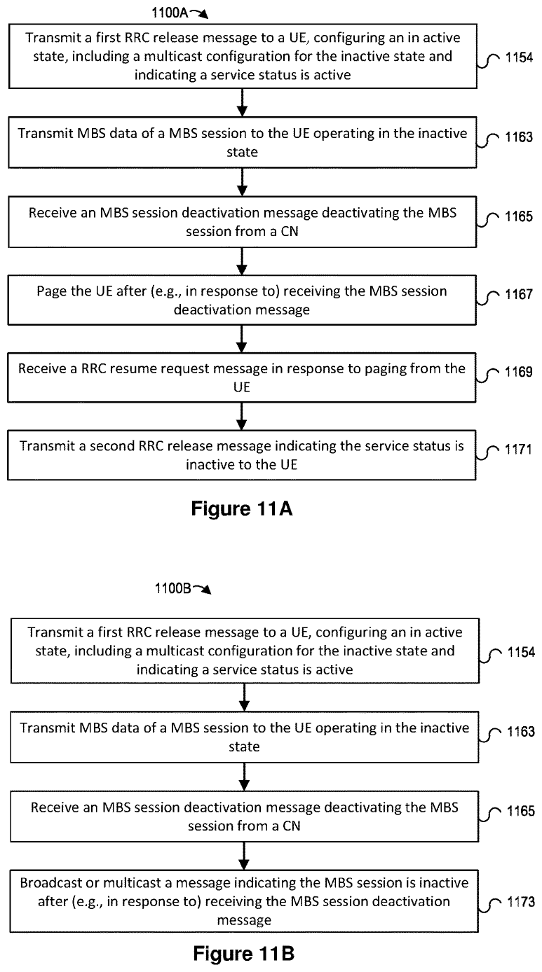

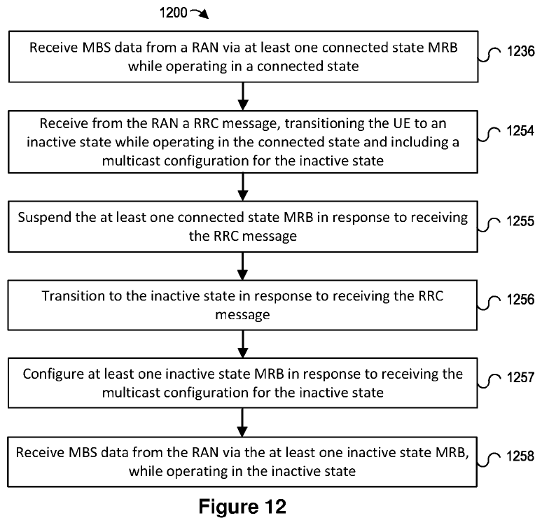

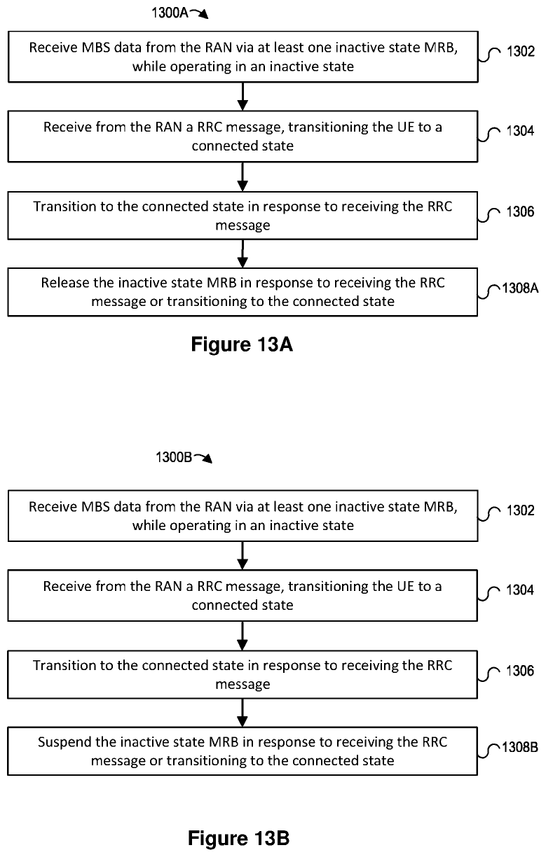

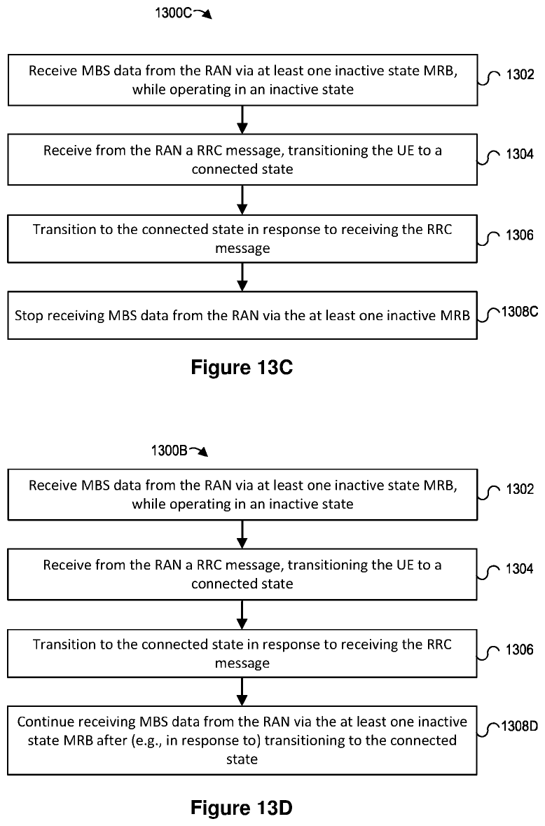

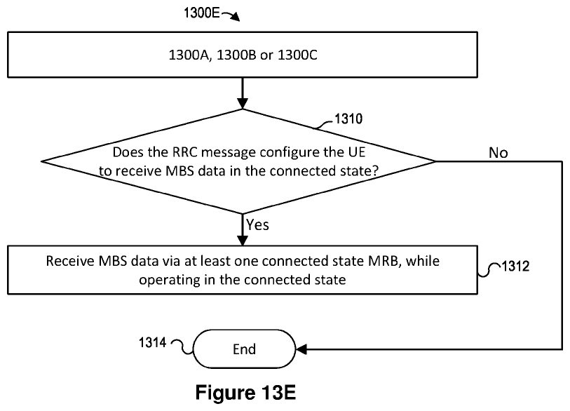

Turning now to FIGS. 8-13E, these figures generally illustrate various methods in which a RAN node configures and performs multicast communication with a UE in an inactive state and after RRC state transitions. FIG. 8 illustrates that a source RAN node configures a UE to perform MBS data reception in a connected state and in an inactive state and transmit the configuration parameters to a target RAN node. FIGS. 9A-9C illustrate that a target RAN node receives configuration parameters for a connected state and a multicast configuration for an inactive state for a UE and reconfigures the UE the multicast configuration for the inactive state. FIG. 10 illustrates that a RAN node performs an RRC resume procedure with a UE and may configure the UE to receive MBS in connected state. FIGS. 11A-11B illustrate that a RAN node configures a UE to receive multicast data in the inactive state and notifies the UE of the MBS service status. FIG. 12 illustrates a UE transitions to the inactive state to receive MBS data in the inactive state and suspends the connected state MRB(s). FIGS. 13A-13E illustrate that a UE manages the inactive state MRB(s) in response to state transitions.

Referring first to FIG. 8, a first RAN node (e.g., the BS 104 or the CU 172 or CU-CP 172A of the BS 104) can implement an example method 800 to perform MBS data transmission with a UE (e.g., the UE 102) in a connected state and in an inactive state and transmit the configuration parameters to a second RAN node (e.g., the BS 106 or the CU 172 or CU-CP 172A of the BS 106).

The method 800 starts at block 828 where the first RAN node transmits a first message including configuration parameters for a connected state to a UE (e.g., events 526, 528). At block 836, the first RAN node communicates with the UE using the configuration parameters while the UE operates in the connected state. (e.g., event 534, 536, 596). At block 854, the first RAN node transmits a second message including a multicast configuration for an inactive state to the UE (e.g., event 552, 554, 588). At block 857, the first RAN node transmits an interface message including the configuration parameters and the multicast configuration to the second RAN node (e.g., event 709).

FIG. 9A is a flow diagram of an example method 900A that a first RAN node (e.g., the BS 106 or the CU 172, CU-CP 172A of the BS 106) can implement to receive from a second RAN node (e.g., the BS 104 or the CU 172 or CU-CP 172A of the BS 104) configuration parameters for a connected state and a multicast configuration for an inactive state for a UE and reconfigures the UE the multicast configuration for the inactive state.

The method 900A begins at block 909, where the first RAN node receives an interface message from the second RAN node for a UE, including a first plurality of configuration parameters for a connected state and a first multicast configuration for an inactive state (e.g., event 709). At block 916, the first RAN node transmits a first message to the UE, including a second plurality of configuration parameters to update (e.g., augment or replace) the first plurality of configuration parameters (e.g., event 716-718). At block 917, the first RAN node releases the first multicast configuration for the inactive state. At block 988, the first RAN node may transmit a second message to the UE, including a second multicast configuration for the inactive state (e.g., event 788).

FIG. 9B is a flow diagram of an example method 900B, similar to the method 900A except that the method 900B includes block 954 instead of blocks 916, 917, 988.

After block 909, the flow proceeds to block 954 where the first RAN node transmits a first message to the UE, excluding a multicast configuration to configure the UE to continuously apply the first multicast configuration for the inactive state (e.g., events 752-754 or 740).

FIG. 9C is a flow diagram of an example method 900B, similar to the method 900A or 900B except that the method 900C includes block 940 instead of blocks 954, 916, 917, 988.

After block 902, the flow proceeds to block 905 where the first RAN node transmits a first message to the UE, including a second multicast configuration for the inactive state to update the first multicast configuration (e.g., events 752-754 or 740).

Referring to FIG. 10, a first RAN node (e.g., the BS 104 or 106, CU 172, CU-CP 172A) can implement an example method 1000 to perform an RRC resume procedure with a UE (e.g., the UE 102) and may configure the UE to receive MBS in the connected state.

The method 1000 starts with blocks 1006 where the first RAN node receives an RRC resume request message from a UE (e.g., event 606-607 or 706-707). At block 1008, the RAN node may receive a UE context of the UE from a second RAN node (e.g., event 708). For example, the first RAN node receives a Retrieve UE Context Response message including the UE context from the second RAN node. At block 1010, the RAN node includes unicast configuration parameters in an RRC resume message. At block 1012, the RAN node determines whether the UE is configured to receive MBS data in the inactive state. If the UE is configured to receive MBS data in the inactive state at block 1012, the flow proceeds to block 1013 where the RAN node includes multicast configuration parameters in the RRC resume message. The flow then proceeds to block 1016 where the RAN node transmits the RRC resume message to the UE (e.g., event 616-618 or 716-718). Alternatively, the RAN node includes the multicast configuration parameters in an RRC reconfiguration message and transmits an RRC reconfiguration message to the UE after transmitting the RRC resume message. Otherwise, if the UE is configured to receive MBS data in the inactive state at block 1012, the flow proceeds to block 1016 directly. That is, the first RAN node refrains from including the multicast configuration parameters to the UE in the RRC resume message.

In some implementations, the Retrieve UE Context Response message or the UE context indicates whether the UE is configured to receive MBS in the inactive.

FIG. 11A is a flow diagram of an example method 1100A that an RAN node (e.g., the BS 104 or 106, CU 172, CU-CP 172A) can implement to configure a UE (e.g., the UE 102) to receive multicast data in the inactive state and notify the UE of the MBS service status.

The method 1100A begins at block 1154 where the RAN node transmits a first RRC release message to a UE, configuring an in active state, including a multicast configuration for the inactive state and indicating a service status is active (e.g., event 552-554, 588). At block 1163, the RAN node transmits MBS data of a MBS session to the UE operating in the inactive state (e.g., event 561-563, 597, 697, 797). At block 1165, the RAN node receives an MBS session deactivation message deactivating the MBS session from a CN. At block 1167, the RAN node pages the UE after (e.g., in response to) receiving the MBS session deactivation message. At block 1169, the RAN node receives an RRC resume request message in response to paging from the UE. At block 1171, the RAN node transmits a second RRC release message indicating the service status is inactive to the UE.

FIG. 11B is a flow diagram of an example method 1100B, similar to the method 1100A except that the method 1100B includes block 1173 instead of blocks 1167, 1169, 1171.

After the block 1165, the flow proceeds to block 1173 where the RAN node broadcasts or multicasts a message indicating the MBS session is inactive after (e.g., in response to) receiving the MBS session deactivation message. In some implementations, the message is a SIB (e.g., SIB 23, SIB 24, or SIBx-r18 where x can be 22, 23, 24, 25, or 26). In other implementations, the message is a MBS multicast configuration message (e.g., MBSMulticastConfiguration).

FIG. 12 is a flow diagram of an example method 1200 that a UE (e.g., the UE 102) can implement to transition to the inactive state to receive MBS data in the inactive state and suspends the connected state MRB(s) in response to a configuration from a RAN node (e.g., the BS 104 or 106, CU 172, CU-CP 172A).

The method 1200 begins at block 1236 where the UE receives MBS data from a RAN via at least one connected state MRB while operating in a connected state (e.g., event 534-536, 596). At block 1254, the UE receives from the RAN node an RRC message, transitioning the UE to an inactive state while operating in the connected state and including a multicast configuration for the inactive state (e.g., event 552-554, 588). At block 1255, the UE suspends the at least one connected state MRB in response to receiving the RRC message. At block 1256, the UE transitions to the inactive state in response to receiving the RRC message (e.g., event 556). At block 1257, the UE configures at least one inactive state MRB in response to receiving the multicast configuration for the inactive state. At block 1258 the UE receives MBS data from the RAN via the at least one inactive state MRB, while operating in the inactive state (e.g., event 558).

FIG. 13A is a flow diagram of an example method 1300A that a UE (e.g., the UE 102) can implement to manage inactive state MRB(s) in response to state transition configurations.

The method 1300A begins at block 1302 where the UE receives MBS data from the RAN via at least one inactive state MRB, while operating in an inactive state (e.g., event 561-563, 597, 697, 797). At block 1304, the UE receives from the RAN an RRC message, transitioning the UE to a connected state (e.g., event 616-618, 716-718). At block 1306, the UE transitions to the connected state in response to receiving the RRC message (e.g., event 604, 704). At block 1308A, the UE releases the inactive state MRB in response to receiving the RRC message or transitioning to the connected state.

In some implementations, the RRC message is an RRC resume message. In other implementations, the RRC message is an RRC setup message.

FIG. 13B is a flow diagram of an example method 1300B, similar to the method 1300A except that the method 1300B includes block 1308B instead of block 1308A. At block 1308B, the UE suspends the inactive state MRB in response to receiving the RRC message or transitioning to the connected state.

FIG. 13C is a flow diagram of an example method 1300C, similar to the method 1300A or 1300B except that the method 1300C includes block 1308C instead of block 1308A or 1308B. At block 1308C, the UE stops receiving MBS data from the RAN via the at least one inactive MRB.

FIG. 13D is a flow diagram of an example method 1300D, similar to the method 1300A, 1300B, or 1300C except that the method 1300D includes block 1308D instead of block 1308A, 1308B, or 1308C. At block 1308D, the UE continues receiving MBS data from the RAN via the at least one inactive state MRB after (e.g., in response to) transitioning to the connected state.

FIG. 13E is a flow diagram of an example method 1300E, which comprises some operations of method 1300A, 1300B, or 1300C and additionally includes blocks 1310, 1312, and 1314. The method 1300E begins at a block following 1300A, 1300B or 1300C. The flow proceeds to block 1310 where the UE determines whether the RRC message configures the UE to receive MBS data in the connected state. If the RRC message configures the UE to receive MBS data in the connected state, the flow further proceeds to block 1312 where the UE receives MBS data via at least one connected state MRB, while operating in the connected state. Otherwise, the flow proceeds to block 1314 without further actions.

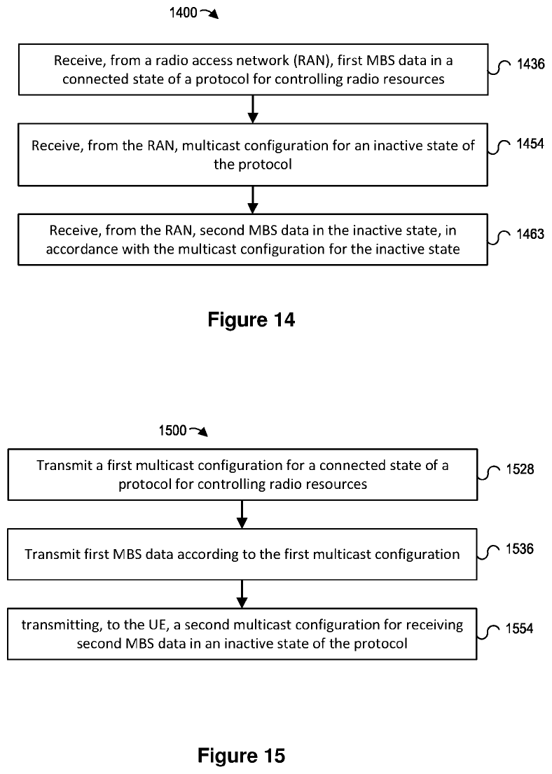

FIG. 14 is a flow diagram of a method 1400, implemented in a UE (e.g., the UE 102), for receiving multicast and/or broadcast services (MBS) data.

The method 1400 begins at block 1436 with the UE receiving, from a radio access network (RAN) (e.g., the BS 104 or 106, CU 172, CU-CP 172A), first MBS data in a connected state of a protocol for controlling radio resources (e.g., event 536, 1236). The first MBS data can be received via a connected state multicast radio bearer (MRB.

At block 1454, the UE receives, from the RAN, multicast configuration for an inactive state of the protocol (e.g., event 552-554, 588, 1254).

At block 1463, the UE receives, from the RAN, second MBS data in the inactive state, in accordance with the multicast configuration for the inactive state (e.g., event 563, 1263). The second MBS data can be received via an inactive state MRB. The method 1400 can include suspending the connected state MRB in response to transitioning from the connected state to the inactive state (e.g., event 1255). The method 1400 can include releasing the inactive state MRB in response to transitioning from the inactive state to the connected state (e.g., event 1308A). The method 1400 can include suspending the inactive state MRB in response to transitioning from the inactive state to the connected state (e.g., event 1308B).

The method 1400 can further include receiving, from the RAN, a command to transition from the connected state to the inactive state. The command can include an indication of whether an MBS session with which the first MBS data is associated is active. The indication can be similar to that shown with reference to FIG. 5B, describing an active/non-active indicator. The command can indicate that the MSB session with which the first MSB data is associated is inactive. The method 1400 can further comprise receiving, subsequently to the receiving of the multicast configuration for the inactive state, a multicast group notification message including an identify of an MBS session with which the second MBS data is associated (e.g., event 578).

The method 1400 can further include determining to resume the radio connection and, in response to the determining, suspending the receiving of the second MBS data in the inactive state (e.g., event 605).

FIG. 15 is a flow diagram of a configuration method 1500 implemented in a RAN node. A first RAN node (e.g., the BS 104 or the CU 172 or CU-CP 172A of the BS 104) can implement an example method 1500 to perform MBS data transmission with a UE (e.g., the UE 102) in a connected state and in an inactive state and transmit the configuration parameters to a second RAN node (e.g., the BS 106 or the CU 172 or CU-CP 172A of the BS 106).

The method 1500 starts at block 1528 with the first RAN node transmitting, to a UE, a first multicast configuration for a connected state of a protocol for controlling radio resources (e.g., events 526, 528). At block 1536, the first RAN transmits first MBS data according to the first multicast configuration (e.g., event 534, 536, 596). At block 1554, the first RAN node transmits, to the UE, a second multicast configuration for receiving second MBS data in an inactive state of the protocol (e.g., event 552, 554, 588).

In method 1500, the first multicast configuration can configure a connected state MRB, and the second multicast configuration configures an inactive state MRB. The second multicast configuration includes a MulticastConfigInactive information element (IE). The first RAN node may transmit, to a second RAN node, an interface message including the first multicast configuration and the multicast configuration (e.g., event 808). The transmitting of the second multicast configuration can be in response to determining that the UE supports MBS reception in the inactive state (e.g., event 1008).

In method 1500, the RAN node can receive, from a core network (CN), an indication that the MBS session is deactivated (e.g., event 1106). The RAN node can transmit, to the UE and in response to the receiving of the indication, an indication that the MBS session is deactivated (e.g., events 1112, 1109). The indication can include an RRC release command to the UE.

The following list of examples reflects a variety of the embodiments explicitly contemplated by the present disclosure.
Example 1. A method for receiving multicast and/or broadcast services (MBS) data, the method implemented in a user equipment (UE) and comprising: receiving, from a radio access network (RAN), first MBS data in a connected state of a protocol for controlling radio resources; receiving, from the RAN, multicast configuration for an inactive state of the protocol; and receiving, from the RAN, second MBS data in the inactive state, in accordance with the multicast configuration for the inactive state.
Example 2. The method of example 1, wherein: the first MBS data is received via a connected state multicast radio bearer (MRB); the second MBS data is received via an inactive state MRB; suspending the connected state MRB in response to transitioning from the connected state to the inactive state.
Example 3. The method of example 2, further comprising: receiving, from the RAN in the connected state, a Radio Resource Control (RRC) reconfiguration message including a configuration for the connected state MRB.
Example 4. The method of any of the preceding examples, wherein: the multicast configuration for the inactive state includes a MulticastConfigInactive information element (IE).
Example 5. The method of any of the preceding examples, wherein: the multicast configuration for the inactive state includes a Packet Data Convergence Protocol (PDCP) configuration.
Example 6. The method any of the preceding examples, wherein: the multicast configuration for the inactive state is received in an RRC release command.
Example 7. The method of example 1 or 2, further comprising: receiving, from the RAN, a command to transition from the connected state to the inactive state, the command including an indication of whether an MBS session with which the first MBS data is associated is active.
Example 8. The method of example 7, wherein: the command indicates that the MBS session with which the first MBS data is associated is inactive; the method further comprising: receiving, subsequently to the receiving of the multicast configuration for the inactive state, a multicast group notification message including an identify of an MBS session with which the second MBS data is associated.
Example 9. The method of Example 8, wherein: the multicast group notification message is a Paging message.
Example 10. The method of example 2, further comprising: releasing the inactive state MRB in response to transitioning from the inactive state to the connected state.
Example 11. The method of example 2, further comprising: suspending the inactive state MRB in response to transitioning from the inactive state to the connected state.
Example 12. The method of example 2, further comprising: stopping the receiving of the second MBS data over the inactive state MRB in response to transitioning from the inactive state to the connected state.
Example 13. The method of any of examples 10-12, wherein: the transitioning from the inactive state to the connected state is in response to receiving an RRC message; the method further comprising: when the RRC message configures the UE to receive MBS data in the connected state, receiving third MBS data in the connected state.
Example 14. The method of example 10, further comprising: continuing the receiving of the second MBS data over the inactive state MRB in response to transitioning from the inactive state to the connected state.
Example 15. The method of any of the preceding examples, further comprising: determining to resume the radio connection; and in response to the determining, suspending the receiving of the second MBS data in the inactive state.
Example 16. The method of example 15, further comprising: resuming the receiving of the second MBS data after transitioning from the inactive state to the connected state.
Example 17. A configuration method implemented in a radio access network (RAN) node, the method comprising: transmitting, to a UE, a first multicast configuration for a connected state of a protocol for controlling radio resources; transmitting to the UE, first MBS data according to the first multicast configuration; and transmitting, to the UE, a second multicast configuration for receiving second MBS data in an inactive state of the protocol.
Example 18. The method of example 17, wherein: the first multicast configuration configures a connected state MRB; and the second multicast configuration configures an inactive state MRB.
Example 19. The method of example 17, wherein: the second multicast configuration for includes a MulticastConfigInactive information element (IE).
Example 20. The method of example 17, wherein: the RAN node is a first RAN node; the method further comprising: transmitting, to a second RAN node, an interface message including the first multicast configuration and the multicast configuration.
Example 21. The method of example 17 or 18, wherein: the transmitting of the second multicast configuration is in response to determining that the UE supports MBS reception in the inactive state.
Example 22. The method of example 17, further comprising: receiving, from a core network (CN), an indication that the MBS session is deactivated; transmitting, to the UE and in response to the receiving of the indication, an indication that the MBS session is deactivated.
Example 23. The method of example 22, wherein: the transmitting of the indication, an indication that the MBS session is deactivated includes transmitting an RRC release command to the UE.
Example 24. The method of example 22, wherein: the transmitting of the indication, an indication that the MBS session is deactivated includes broadcasting or multicasting the indication.
Example 25. The method of example 24, wherein the multicasting of the indication includes transmitting a multicast group notification to a plurality of UEs including the UE.
Example 26. An apparatus comprising processing hardware and configured to implement a method of any of the preceding examples.

The following additional considerations apply to the foregoing discussion.

Generally speaking, description for one of the above figures can apply to another of the above figures. An event or block described above can be optional or omitted. For example, an event or block with dashed lines in the figures can be optional or omitted. In some cases, an event or block with solid lines in the figures can still be optional or omitted if the event or block is not necessary. In some implementations, “message” is used and can be replaced by “information element (IE)”. In some implementations, “IE” is used and can be replaced by “field”. In some implementations, “configuration” can be replaced by “configurations” or the configuration parameters. In some implementations, “MBS” can be replaced by “multicast” or “multicast MBS”. In some implementations, “MBS data” can be replaced by “multicast transmission(s)”. In some implementations, “multicast MBS” and “multicast transmission(s)” are interchangeable. In some implementations, “multicast communication”, “multicast reception” and “multicast transmission” are interchangeable. In some implementations, “SPS multicast” can be replaced by “multicast SPS”. Similarly, “dynamic scheduling multicast” can be replaced by “multicast dynamic”. In some implementations, “identifier” can be replaced by “identity”. In some implementations, “CFR” is used and can be replaced by “MBS BWP”. In some implementations, the term “transport layer configuration” can be replaced by “tunnel information” or “transport layer information”. In some implementations, “in accordance with” can be replaced by “using”. In some implementations, “unicast communication” can replaced by “unicast data communication”.

A user device in which the techniques of this disclosure can be implemented (e.g., the UE 102A, 102B, or UE 103) can be any suitable device capable of wireless communications such as a smartphone, a tablet computer, a laptop computer, a mobile gaming console, a point-of-sale (POS) terminal, a health monitoring device, a drone, a camera, a media-streaming dongle or another personal media device, a wearable device such as a smartwatch, a wireless hotspot, a femtocell, or a broadband router. Further, the user device in some cases may be embedded in an electronic system such as the head unit of a vehicle or an advanced driver assistance system (ADAS). Still further, the user device can operate as an internet-of-things (IoT) device or a mobile-internet device (MID). Depending on the type, the user device can include one or more general-purpose processors, a computer-readable memory, a user interface, one or more network interfaces, one or more sensors, etc.

Certain embodiments are described in this disclosure as including logic or a number of components or modules. Modules may can be software modules (e.g., code stored on non-transitory machine-readable medium) or hardware modules. A hardware module is a tangible unit capable of performing certain operations and may be configured or arranged in a certain manner. A hardware module can comprise dedicated circuitry or logic that is permanently configured (e.g., as a special-purpose processor, such as a field programmable gate array (FPGA) or an application-specific integrated circuit (ASIC)) to perform certain operations. A hardware module may also comprise programmable logic or circuitry (e.g., as encompassed within a general-purpose processor or other programmable processor) that is temporarily configured by software to perform certain operations. The decision to implement a hardware module in dedicated and permanently configured circuitry, or in temporarily configured circuitry (e.g., configured by software) may be driven by cost and time considerations.

When implemented in software, the techniques can be provided as part of the operating system, a library used by multiple applications, a particular software application, etc. The software can be executed by one or more general-purpose processors or one or more special-purpose processors.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

Upon reading this disclosure, those of skill in the art will appreciate still additional alternative structural and functional designs for performing a HARQ process to transmit MBS data through the disclosed principles herein. Thus, while particular embodiments and applications have been illustrated and described, it is to be understood that the disclosed embodiments are not limited to the precise construction and components disclosed herein. Various modifications, changes and variations, which will be apparent to those of ordinary skill in the art, may be made in the arrangement, operation and details of the method and apparatus disclosed herein without departing from the spirit and scope defined in the appended claims.

1. A method for receiving multicast and/or broadcast services (MBS) data, the method implemented in a user equipment (UE) and comprising:
receiving, from a radio access network (RAN), MBS data in an inactive state of a protocol for controlling radio resources and via an inactive state multicast radio bearer (MRB);
in response to transitioning from the inactive state to a connected state, releasing the inactive state MRB.

2. The method of claim 1, further comprising:
receiving, from the RAN, a multicast configuration for the inactive state of the protocol; and
receiving, from the RAN, second MBS data in the inactive state, in accordance with the multicast configuration for the inactive state.

3. The method of claim 1, further comprising:
receiving, from the RAN, a command to transition from the connected state to the inactive state, the command including an indication of whether an MBS session with which the first MBS data is associated is active.

4. The method of claim 3, wherein:
the command indicates that the MBS session with which the first MBS data is associated is inactive; and the method further comprising:
receiving, subsequently to the receiving of the multicast configuration for the inactive state, a multicast group notification message including an identify of an MBS session with which the second MBS data is associated

5. The method of claim 1, further comprising:
in response to transitioning from the connected state to the inactive state, not suspending an inactive state MRB.

6. A configuration method implemented in a radio access network (RAN) node, the method comprising:
transmitting, to a UE, a first multicast configuration for a connected state of a protocol for controlling radio resources;
transmitting to the UE, first MBS data according to the first multicast configuration; and
transmitting, to the UE, a second multicast configuration for receiving second MBS data in an inactive state of the protocol.

7. The method of claim 6, wherein:
the RAN node is a first RAN node; the method further comprising:
transmitting, to a second RAN node, an interface message including the first multicast configuration and the multicast configuration.

8. The method of claim 6, wherein:
the transmitting of the second multicast configuration is in response to determining that the UE supports MBS reception in the inactive state.

9. The method of claim 6, further comprising:
receiving, from a core network (CN), an indication that the MBS session is deactivated;
transmitting, to the UE and in response to the receiving of the indication, an indication that the MBS session is deactivated.

10. The method of claim 9, wherein:
the transmitting of the indication, an indication that the MBS session is deactivated includes transmitting an RRC release command to the UE.

11. The method of claim 9, wherein:
the transmitting of the indication, an indication that the MBS session is deactivated includes broadcasting or multicasting the indication.

12. The method of claim 11, wherein the multicasting of the indication includes transmitting a multicast group notification to a plurality of UEs including the UE.

13. An apparatus comprising processing hardware and configured to receive multicast and/or broadcast services (MBS) data, including:
receive, from a radio access network (RAN), MBS data in an inactive state of a protocol for controlling radio resources and via an inactive state multicast radio bearer (MRB);
in response to transitioning from the inactive state to a connected state, release the inactive state MRB.

14. (canceled)

15. (canceled)

16. The apparatus of claim 13, further configured to:
receive, from the RAN, a multicast configuration for the inactive state of the protocol; and
receive, from the RAN, second MBS data in the inactive state, in accordance with the multicast configuration for the inactive state.

17. The apparatus of claim 13, further configured to:
receive, from the RAN, a command to transition from the connected state to the inactive state, the command including an indication of whether an MBS session with which the first MBS data is associated is active.

18. The apparatus of claim 13, wherein:
the command indicates that the MBS session with which the first MBS data is associated is inactive; the apparatus further configured to:
receive, subsequently to the receiving of the multicast configuration for the inactive state, a multicast group notification message including an identify of an MBS session with which the second MBS data is associated.

19. The apparatus of claim 13, further configured to:
in response to transitioning from the connected state to the inactive state, not suspend an inactive state MRB.
